(19) United States
(12) Patent Application Publication
(10) Pub. No.: US 2024/0193685 A1
(43) Pub. Date: Jun. 13, 2024

(54) SYSTEMS AND METHODS FOR AN ARTIFICIAL INTELLIGENCE TRADING PLATFORM

(71) Applicant: Jacov Baloul, Weston, FL (US)

(72) Inventor: Jacov Baloul, Weston, FL (US)

(21) Appl. No.: 18/490,438

(22) Filed: Oct. 19, 2023

Related U.S. Application Data
(60) Provisional application No. 63/380,119, filed on Oct. 19, 2022.

(51) Int. Cl. G06Q 40/04

(52) U.S. Cl. CPC G06Q 40/04

(57) ABSTRACT

A method includes determining changes in value of a trading asset over a predetermined period of time. The asset may be electronically traded. The method includes calculating a score for the trading asset based on the changes in value of the asset over the predetermined period of time. The score represents a magnitude change based on a weighted calculation of the changes in value at different times in the predetermined period of time. The method also includes generating a signal in response to the score meeting a predetermined threshold. Further, the method includes transmitting the signal to one or more targets.

### CROSS-REFERENCE TO RELATED APPLICATIONS

This application claims the benefit of priority of U.S. provisional application No. 63/380,119, filed Oct. 19, 2022, the entire contents of which are herein incorporated by reference.

### BACKGROUND

The present disclosure relates to electronic and network communication systems and, more particularly, to systems and methods for providing an electronic trading platform.

Traditional money managers use expensive trading systems that require expensive, inefficient, high maintenance, on-prem (close to the fiber connection of the market), supercomputer, data center capabilities combined with human quants to deliver results and take trading positions.

As can be seen, there is a need for an affordable trading system that can deliver similar results. The present disclosure solves this problem by creating an easy to use, feature rich, unique, social, fun, trading platform with all the sophisticated heavy lifting behind the scenes.

### SUMMARY

In one aspect of the present disclosure, a method includes determining changes in value of a trading asset over a predetermined period of time. The asset may be electronically traded. The method includes calculating a score for the trading asset based on the changes in value of the asset over the predetermined period of time. The score represents a magnitude change based on a weighted calculation of the changes in value at different times in the predetermined period of time. The method also includes generating a signal in response to the score meeting a predetermined threshold. Further, the method includes transmitting the signal to one or more targets.

In another aspect of the present disclosure, a computer-readable medium stores instructions for causing one or more processors to perform a method. The method includes determining changes in value of a trading asset over a predetermined period of time. The asset may be electronically traded. The method includes calculating a score for the trading asset based on the changes in value of the asset over the predetermined period of time. The score represents a magnitude change based on a weighted calculation of the changes in value at different times in the predetermined period of time. The method also includes generating a signal in response to the score meeting a predetermined threshold. Further, the method includes transmitting the signal to one or more targets.

In another aspect of the present disclosure, a system includes one or more memory devices storing instructions and one or more processors. The one or more processors are configured to execute the instruction to perform a method. The method includes determining changes in value of a trading asset over a predetermined period of time. The asset may be electronically traded. The method includes calculating a score for the trading asset based on the changes in value of the asset over the predetermined period of time. The score represents a magnitude change based on a weighted calculation of the changes in value at different times in the predetermined period of time. The method also includes generating a signal in response to the score meeting a predetermined threshold. Further, the method includes transmitting the signal to one or more targets.

### BRIEF DESCRIPTION OF THE DRAWINGS

FIG. 1 is a block diagram of a network trading environment, including an artificial intelligence trading system, according to aspects of the present disclosure;

FIG. 2 is a block diagram of a signal generation module of the artificial intelligence trading system of FIG. 1, according to aspects of the present disclosure;

FIG. 3 is a block diagram of an artificial intelligence trader module of the artificial intelligence trading system of FIG. 1, according to aspects of the present disclosure;

FIG. 4 is a flow diagram of a method for generating signals performed by the artificial intelligence trading system of FIG. 1, according to aspects of the present disclosure;

FIGS. 5 and 6 are logical diagrams of the method of FIG. 4, according to aspects of the present disclosure;

FIG. 7 is a flow diagram of a method for establishing an AI-generated trading position, according to aspects of the present disclosure;

FIG. 8 is a logic diagram of trading processes performed by the artificial intelligence trading system of FIG. 1, according to aspects of the present disclosure;

FIG. 9 is a block diagram of various interfaces generated by the artificial intelligence trading system of FIG. 1, according to aspects of the present disclosure;

FIGS. 10A-10G are diagrams of navigation interfaces generated by the artificial intelligence trading system of FIG. 1, according to aspects of the present disclosure;

FIGS. 11A-11C, 12A-12C, 13A, and 13B are diagrams of trading strategy interfaces generated by the artificial intelligence trading system of FIG. 1, according to aspects of the present disclosure;

FIGS. 14A-14E are diagrams of trading strategy creation interfaces generated by the artificial intelligence trading system of FIG. 1, according to aspects of the present disclosure;

FIGS. 15A-15D are diagrams of trading position creation interfaces generated by the artificial intelligence trading system of FIG. 1, according to aspects of the present disclosure;

FIG. 16 is a diagram of a top picks interface generated by the artificial intelligence trading system of FIG. 1, according to aspects of the present disclosure;

FIG. 17 is a diagram of a configuration interface generated by the artificial intelligence trading system of FIG. 1, according to aspects of the present disclosure;

FIG. 18 is a diagram of an overview interface generated by the artificial intelligence trading system of FIG. 1, according to aspects of the present disclosure;

FIGS. 19A-19D are diagrams of trading position creation interfaces generated by the artificial intelligence trading system of FIG. 1, according to aspects of the present disclosure;

FIGS. 20A and 20B are diagrams of trading position creation interfaces generated by the artificial intelligence trading system of FIG. 1, according to aspects of the present disclosure;

FIGS. 21A-210 are diagrams of trend interfaces generated by the artificial intelligence trading system of FIG. 1, according to aspects of the present disclosure;

FIGS. 22A and 22B are diagrams of analysis interfaces generated by the artificial intelligence trading system of FIG. 1, according to aspects of the present disclosure; and

FIGS. 23A and 23B are diagrams of analysis interfaces generated by the artificial intelligence trading system of FIG. 1, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

Broadly, an embodiment of the present disclosure provides a system and method to simplify complex sophisticated Financial Hedge Fund Technology (FinTech) and deliver these capabilities to the average person.

The system and method of the present disclosure may provide a high frequency, high performance, multi-tenant algorithm trading platform at scale in a cloud with artificial intelligence, machine learning, natural language processing (NLP), stock/crypto/forex/symbol agnostic recommendation engine to perform robotic quantitative analysis to suggest and create trading strategies and trading signals, based on automated risk and reward calculations, with a sophisticated rules engine that can be used by non-professionals through unique, simple to use, software application interfaces, including voice and mobile interfaces. The system can also provide a social network and marketplace capabilities where users can buy, sell, share, clone, and customize their own trading strategies.

The system may offer the expensive, super-computer trading technologies of FinTech and hedge fund money managers in a cost-efficient, scalable way while automating expensive human quantitative analysis (quants).

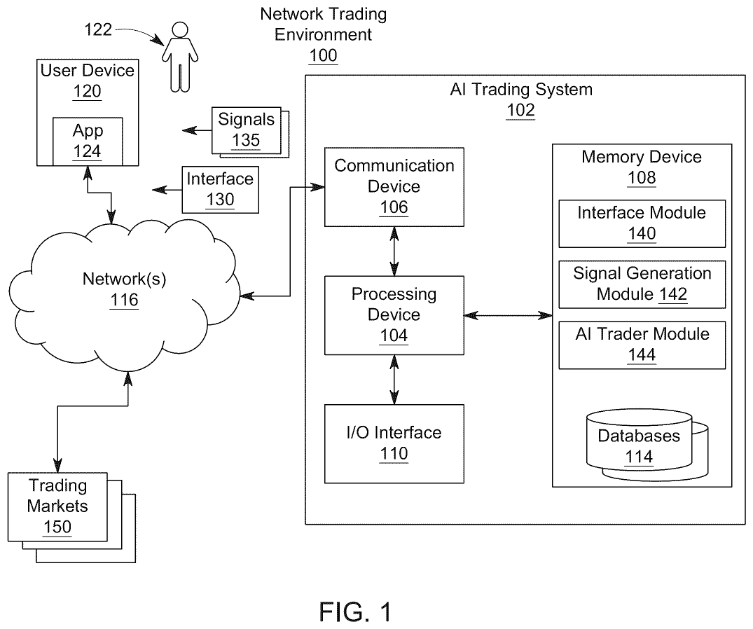

Referring now to FIG. 1, FIG. 1 illustrates a network trading environment 100, according to aspects of the present disclosure. The network trading environment 100 includes an artificial intelligence (AI) trading system 102 that automates quantitative analysis while reducing the computing resources required to perform the analysis. While FIG. 1 illustrates various components of the network trading environment 100, additional components can be added, and existing components can be removed.

As illustrated in FIG. 1, the AI trading system 102 includes one or more processing devices, herein processing device 104, coupled to a communication device 106. The processing device 104 is also coupled to a memory device 108, and an input/output (“I/O”) interface 110. In embodiments, the communication interface 104 enables the testing system 102 to communicate with other devices and systems via one or more networks 116. The AI trading system 102 can communicate with a user device 120 via the network 116. A user 122 can utilize the user device 120 to communicate with the AI trading system 102. The user device 120 can include one or more electronic devices such as a laptop computer, a desktop computer, a tablet computer, a smartphone, a thin client, a smart appliance, and the like. While FIG. 1 illustrates one user device 120, the network trading environment 100 can include multiple user devices operated by the user 122 or operated by other users.

According to the aspects of the present disclosure, the AI trading system 102 enables the user 122, operating a copy of an application 124 executing on the user device 120, to communicate with the AI trading system 102 and leverage the service provided by the AI trading system 102. The AI trading system 102 is configured to provide AI driven trading for one or more trading markets 150.

To perform the process described herein, the AI trading system 102 can store and execute an interface module 140, a signal generation module 142, and an AI trader module 144 to perform the processes and methods described herein. The interface module 140, the signal generation module 142, and the AI trader module 144 can be stored in the memory device 108. The interface module 140, the signal generation module 142, and the AI trader module 144 can include the necessary logic, instructions, and/or programming to perform the processes and methods described in further detail below. The interface module 140, the signal generation module 142, and the AI trader module 144 can be written in any programming language. In embodiments, the application 124 can be a specifically designed application that operates with the AI trading system 102 to perform the processes and methods described herein. In embodiments, the application 124 can be a third-party application, such as a web browser, that communicates with the AI trading system 102 to perform the processes and methods described herein. The memory device 108 can also include one or more databases 114 that store information and data associated with the process and methods described below in further detail.

According to aspects of the present disclosure, the AI trading system 102, for example, via the interface module 140, provides unique interfaces that allow the user 122 to select trading strategies, set user preferences, monitor trading positions, etc. The AI trading system 102, for example, via the interface module 140, provides a social network and marketplace where the user 122 can buy, sell, share, clone, and customize their own trading strategies. The interface module 140 operates to generate and provide graphical user interfaces (GUIs) to the application 122, for example, menus, widgets, text, images, fields, etc., as described below in further detail. The GUIs generated by the interface module 140 can be interactive. The AI trading system 102, for example, via the interface module 140, also provide one or more application programming interface (APIs) that provide connection points for one or more application, e.g., the application 124.

In embodiments, the interface module 140 can implement voice control aspects into the interfaces provided. For example, the user can navigate the interfaces of the AI trading system 102 using the audio input device of the user device 120. The interface module 140 can implement one or more chat-bots to deliver conversation input and output with a user.

The AI trading system 102, for example, via the signal generation module 142 and the AI trader module 144, provides automation of quantitative analysis and automation of trading operations. The AI trading system 102, for example, via the signal generation module 142 and the AI trader module 144, can operate in trading markets 150 using symbol agnostic techniques. The AI trading system 102, for example, via the signal generation module 142 and the AI trader module 144, can operate a decoupled API, AI trading system, which can be applied to any type of trade market 150, e.g., stock markets, crypto, forex, etc. The AI trading system 102, for example, via the signal generation module 142 and the AI trader module 144, can operate one or more rules engines with sophisticated capabilities for implementing complex trading strategies such as user defined tiered buy/sell levels and positions; user defined multi-level Stop Loss/Stop Win, entry and exit position automation; and activate/de-activate algorithm, e.g., wake up or sleep, for trading bot automation.

In embodiment, the AI trading system 102, via the signal generation module 142 and the AI trader module 144, delivers decision engines and decision logic. The AI trading system 102, via the signal generation module 142 and the AI trader module 144, provides for price action trading automation, e.g., real-time monitoring of values of assets and corresponding trading according to trading strategies. The AI trading system 102, via the signal generation module 142 and the AI trader module 144, provides price action and price movement magnitude detection through the AI and machine-learning (MI) algorithms that determine and analyze the values of the assets over a predetermined time period. For example, the AI trading system 102, via the signal generation module 142 and the AI trader module 144, can determine and analyze the value of an asset for varying time periods, e.g., 1 hour, 1 day, 1 week, to determine the trend of the asset and the magnitude of the trend.

In embodiments, the AI trading system 102 reduces the computational complexity of professional quant trading systems into easy-to-use, unique interfaces with AI and ML. The AI trading system 102 implements gamification of trading using fun interfaces and AI on a sophisticated multiplayer multi-tenant trading platform. The the AI trading system 102, via the signal generation module 142 and the AI trader module 144, translates user-defined trading strategy templates into actual trading plans and algorithms that are executed by the personalized trading AI rules engine.

In embodiments, the databases 114 can utilize various database storage engine types, and actual data types. For example, the the databases 114 can utilize i a combination of relational databases & relational SQL schemas as well as non-relational databases with NoSQL data, both at BigData scale. The AI trader system uses a combination of map-reduced data processing techniques on the range of databases mentioned to analyze bigdata at scale. The combination results in a significant reduction of required computer resources and computer storage compared to currently used computer resources used by electronic trading systems. As such, the cost savings for hedge funds who previously relied on clusters of super computers and computer servers that cost millions of dollars, whereas the system mentioned herein in the invention can be run on an affordable home personal computer, which results in a dramatic difference in cost and efficiency.

The processing device 104, the communication device 106, the memory device 108, and the I/O interface 110 can be interconnected via a system bus. The system bus can be and/or include a control bus, a data bus, and address bus, and so forth. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and so forth. As used herein, “processor,” “processing component,” “processing device,” and/or “processing unit” can be used generically to refer to any or all of the aforementioned specific devices, elements, and/or features of the processing device. While FIG. 1 illustrates a single processing device 104, the AI trading system 102 102 can include multiple processing devices 104, whether the same type or different types.

The memory device 108 can be and/or include computerized storage medium capable of storing electronic data temporarily, semi-permanently, or permanently. The memory device 108 can be or include a computer processing unit register, a cache memory, a magnetic disk, an optical disk, a solid-state drive, and so forth. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device. While FIG. 1 illustrates a single memory device 108, the AI trading system 102 102 can include multiple memory devices 108, whether the same type or different types.

The communication device 104 enables the AI trading system 102 102 to communicate with other devices and systems. The communication device 104 can include, for example, a networking chip, one or more antennas, and/or one or more communication ports. The communication device 104 can generate radio frequency (RF) signals and transmit the RF signals via one or more of the antennas. The communication device 104 can generate electronic signals and transmit the RF signals via one or more of the communication ports. The communication device 104 can receive the RF signals from one or more of the communication ports. The electronic signals can be transmitted to and/or from a communication hardline by the communication ports. The communication device 104 can generate optical signals and transmit the optical signals to one or more of the communication ports. The communication device 104 can receive the optical signals and/or can generate one or more digital signals based on the optical signals. The optical signals can be transmitted to and/or received from a communication hardline by the communication port, and/or the optical signals can be transmitted and/or received across open space by the communication device 104.

The communication device 104 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The AI trading system 102 102 can communicate with one or more network resources via the network 116. The one or more network resources can include external databases, social media platforms, search engines, file servers, web servers, or any type of computerized resource that can communicate with the *** system 102 via the network 116.

As described above, the AI trading system 102 can include hardware components to perform the processes described herein. In embodiments, one or more of components, hardware, and/or functionality of the AI trading system 102 102 can be hosted and/or instantiated on a “cloud” or “cloud service.” As used herein, a “cloud” or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the AI trading system 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “information,” “content,” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the network environment 100, including the AI trading system 102 and/or the user device 120 can provide I/O devices for outputting information in a format perceptible by a user and receiving input from the user. For example, the AI trading system 102 can communicate with the I/O devices via the I/O interface 110. The I/O devices can display graphical user interfaces (“GUIs”) generated by the AI trading system 102. The I/O devices can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The I/O devices can include an acoustic element such as a speaker, a microphone, and so forth. The I/O devices can include a button, a switch, a keyboard, a touch-sensitive surface, a touchscreen, a camera, a fingerprint scanner, and so forth. The touchscreen can include a resistive touchscreen, a capacitive touchscreen, and so forth.

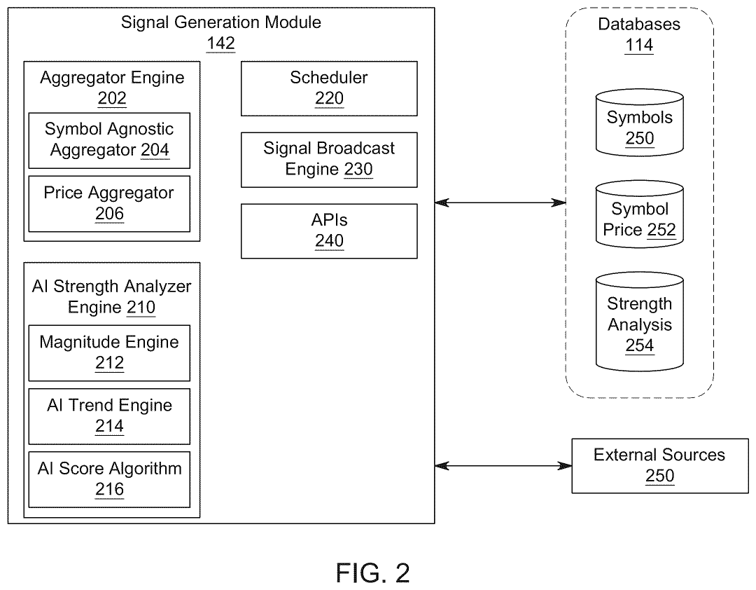

FIG. 2 illustrates an example of the signal generation module 142, according to aspects of the present disclosure. While FIG. 2 illustrates various components of the signal generation module 142, additional components can be added, and existing components can be removed.

The signal generation module 142 can include an aggregator engine 202. The aggregator engine 202 can include a symbol agnostic aggregator 204 and a price aggregator 206. The aggregator engine 202 can retrieve all available and tradable asset symbols, tickers, and pairs into a symbols database 250. The aggregator engine 202 can retrieve values and/or prices for the assets and store the values and/or prices in a symbol price database 252.

The signal generation module 142 can include AI strength analyzer engine 210. The AI strength analyzer engine 210 can include a magnitude engine 212, an AI trend engine 214, and an AI score algorithm 214. The AI strength analyzer engine 210 can be configured to measure an asset symbol gain per a predetermined time period. The AI strength analyzer engine 210 can apply an AI score algorithm to determine the top asset symbols to recommend for trading. The top asset symbols and the strength analysis can be stored in a strength analysis database 254. Algorithm calculates symbol agnostic that can be applied to measure and analyze symbol/asset gain or loss and the magnitude of the win or loss of the trade.

The signal generation module 142 can include a scheduler 220. The scheduler 220 can control the timing and operation of the other components of the signal generation module 142. The signal generation module 142 can also include one or more APIs 240.

The signal generation module 142 can include a signal broadcast engine 230. The signal generation module 142 can be configured to generate a signal 135. A signal represents a recommendation that was determined by the AI strength analyzer engine 210. The signal generation module 142 can transmit the signals to various entities such as the user device 120 and/or the AI trading module 144 for further action.

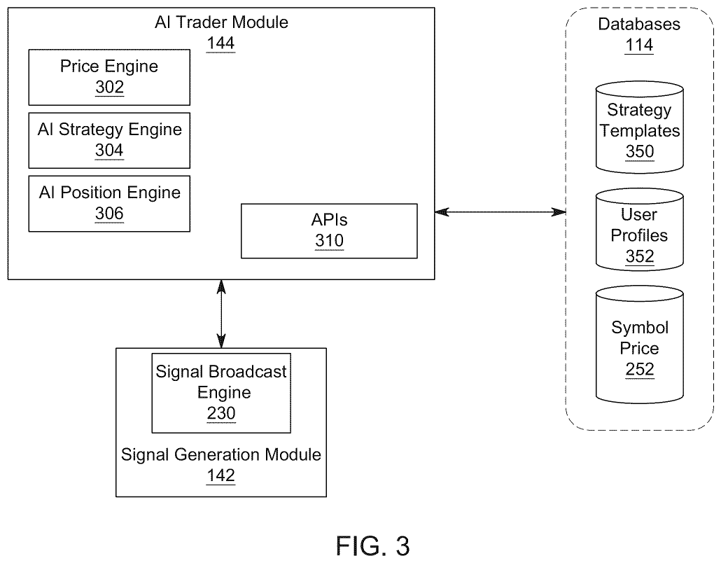

FIG. 3 illustrates an example of the AI trader module 144, according to aspects of the present disclosure. While FIG. 3 illustrates various components of the AI trader module 144, additional components can be added, and existing components can be removed.

The AI trader module 144 can include a price engine 302. The price engine 302 can be configured to determine the current price of an asset. The price engine can communicate with the external sources and/or the symbol price database 252. The AI trader module 144 can also include one or more APIs 310.

The AI trader module 144 can include a AI strategy engine 304. The AI strategy engine 304 can be configured to develop trading strategies based on the signal 135 received from the signals generation module 142, strategy templates 350, user profiles 352, and combinations thereof. The AI strategy engine 304 can include machine learning algorithms and logic to determine trading positions based on the signal 135, strategy templates 350, user profiles 352, and combinations thereof.

The AI trader module 144 can include an AI position engine 306. The AI position engine 306 can be configured to acquire a position in an asset based on the strategy from the AI strategy engine 304. The AI position engine 306 can be configured to monitor and alter the position based on the movement of a value of the asset and the machine learning algorithms.

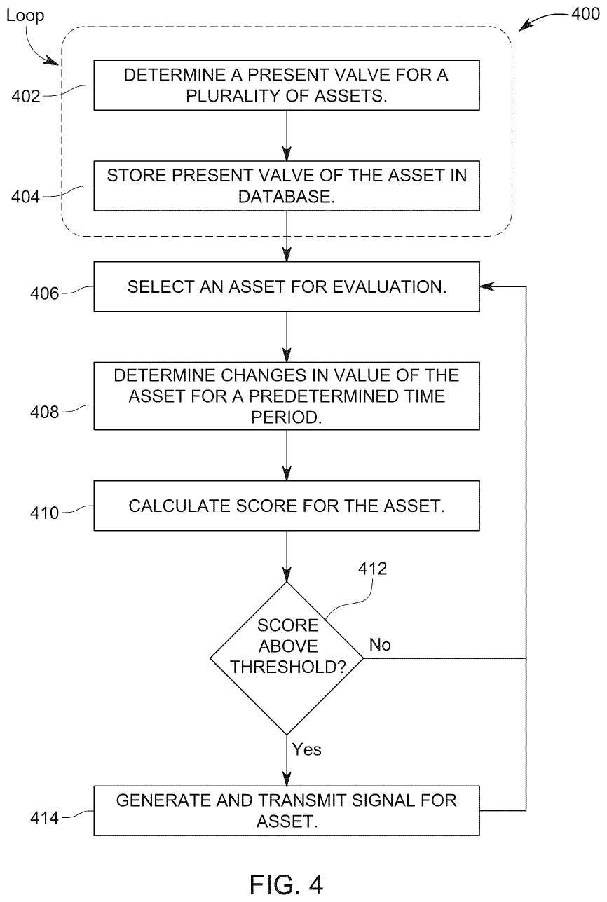

FIG. 4 illustrates a method 400 for generating signals, according to aspects of the present disclosure. While FIG. 4 illustrates various stages of the method 400, additional stages can be added, and existing components can be removed and/or reordered.

In stage 402, a present value of an asset is determined. In embodiments, the AI trader system 102 can determine the present value of an asset, for example, via the network 116. In stage 404, the present value of the asset can be stored in a database. In embodiment, the AI trader system 102 can store the present value of the asset in one or more of the databases 114. The stages 402 and 404 can be repeated in a loop to determine and store the present value at predetermine intervals.

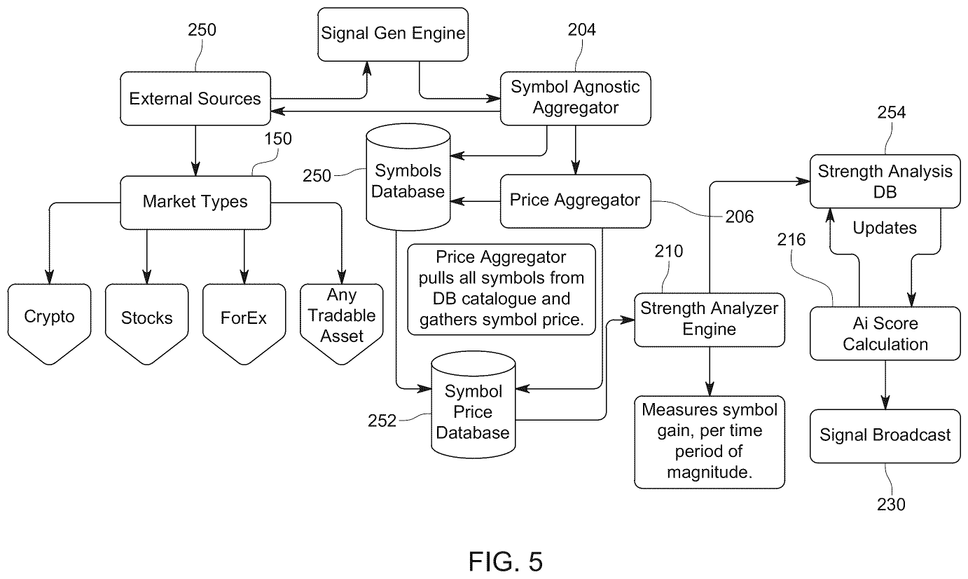

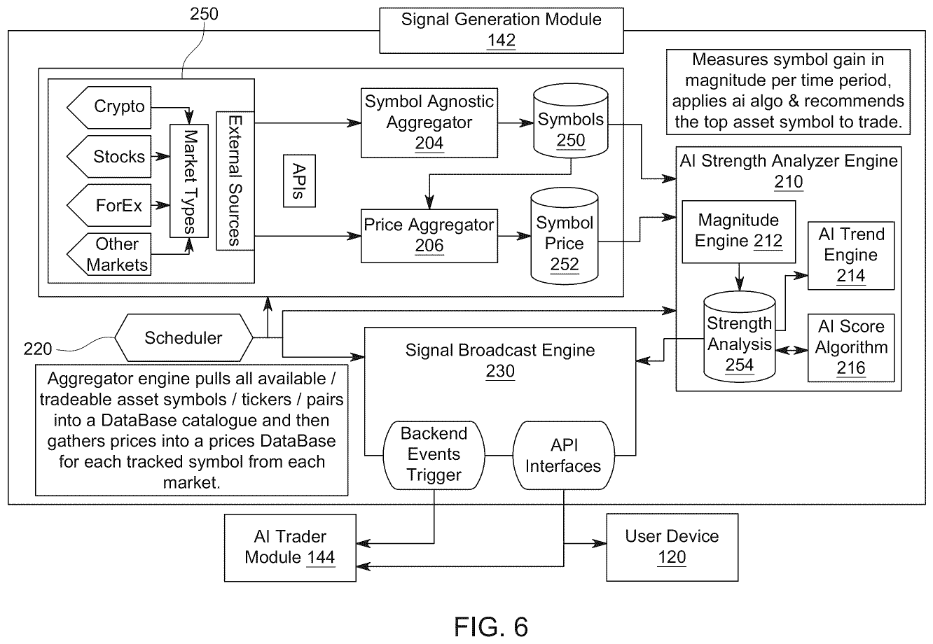

For example, as illustrated in FIGS. 5 and 6, which shows a logical diagram of the method 400 being performed in the AI trader system 102, the signal generation module 142 can obtain the value of various assets, e.g., crypto assets, stocks, ForEx, or any tradable asset, from one or more external sources 602, for example, via the network 116. The external sources can be services that provide present values of the assets. The symbol aggregator 204 can store the symbols and symbol pairs in the symbols database 252. The price aggregator 105 can determine the prices for the assets and asset pairs and store the prices indexed with the symbols in the symbol price database 252.

In stage 406, an asset is selected for evaluation. In stage 408, the changes in value of the asset are determined for a predetermined time period. In 410, a score for the asset is determined.

For example, as illustrated in FIGS. 5 and 6, the AI strength analyzer engine 210, via the magnitude engine 212, can retrieve the prices of an asset from the symbol price database 252. The magnitude engine 212 can determine the value and/or price gain of the asset per predetermined time period. In embodiments, the predetermined time periods can be of varying length, for example, 1 second, 1 minute, 1 hour, 3 hours, 1 day, 5 days, 1 week, 1 month, etc. Then, the AI trend engine applies the AI scoring algorithm to determine a score for the asset.

In stage 412, it is determined whether the score is above a threshold. If the score is not above the threshold, the method 400 can return to stage 406 and evaluate the same asset or a different asset. If the score is above a threshold, in stage 414, a signal for the asset is generated and transmitted. In embodiments, the signal generation module 142 can send the signal to the user device 120 and/or the AI trader module 144.

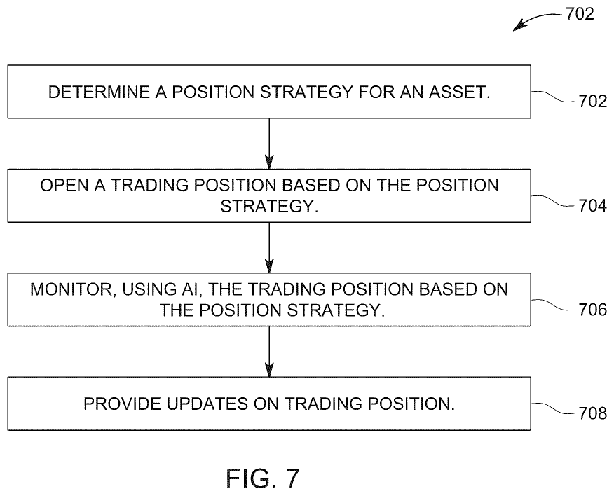

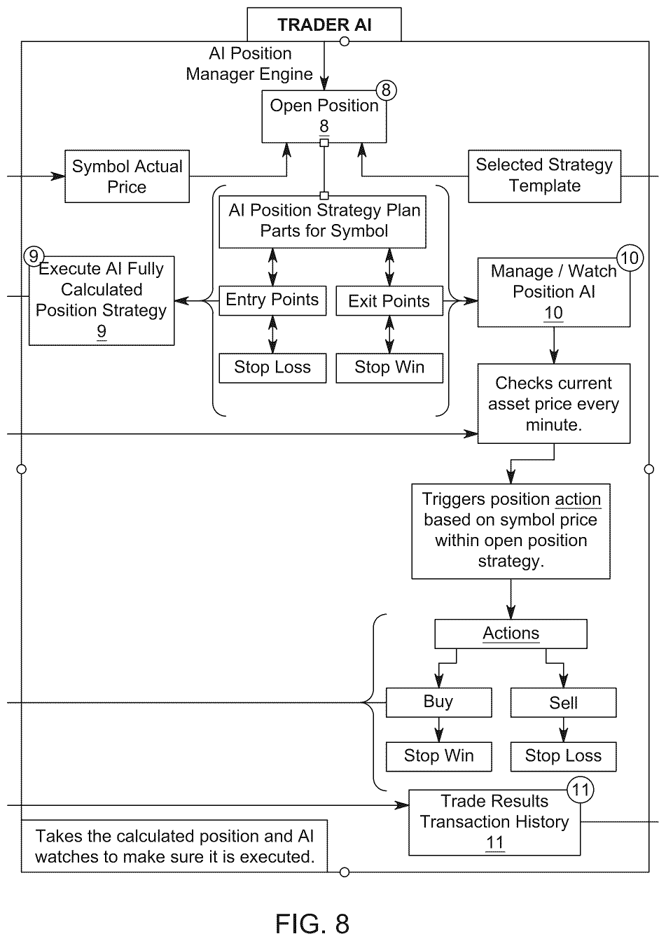

In embodiments, after the signal is generated or at any time, the AI trader system 102 can establish a trading position in an asset. FIG. 7 illustrates a method 700 for establishing an AI-generated trading position, according to aspects of the present disclosure. While FIG. 7 illustrates various stages of the method 700, additional stages can be added, and existing components can be removed and/or reordered.

In stage 702, a position strategy for an asset is determined. In embodiments, the position strategy can be a strategy that is determined by the AI strategy engine 304 based on predetermined factors. The positioned strategy can be determined by the AI strategy engine 304 based on user preferences and/or selections.

In stage 704, a trading position is opened based on the trading strategy. In embodiment, the AI trader module 144 can obtain the value of the asset via the price engine 302. The AI trader module 144, via the AI position engine 306, can execute electronic trades to establish the trading position.

In stage 706, the trading position is monitored using AI based on the position strategy. In embodiments, the AI position engine 304 can periodically obtain the value of the asset via the price engine 302. The AI position engine 304 can apply the obtained values to machine learning algorithms tailored to the position strategy to determine actions to take to maintain the position strategy. FIG. 8 illustrates various examples of actions that can be taken by the AI trader module.

In stage 708, updates are provided on the trading position. In embodiments, AI position engine 304 can provide updates to the user via the interface engine 140.

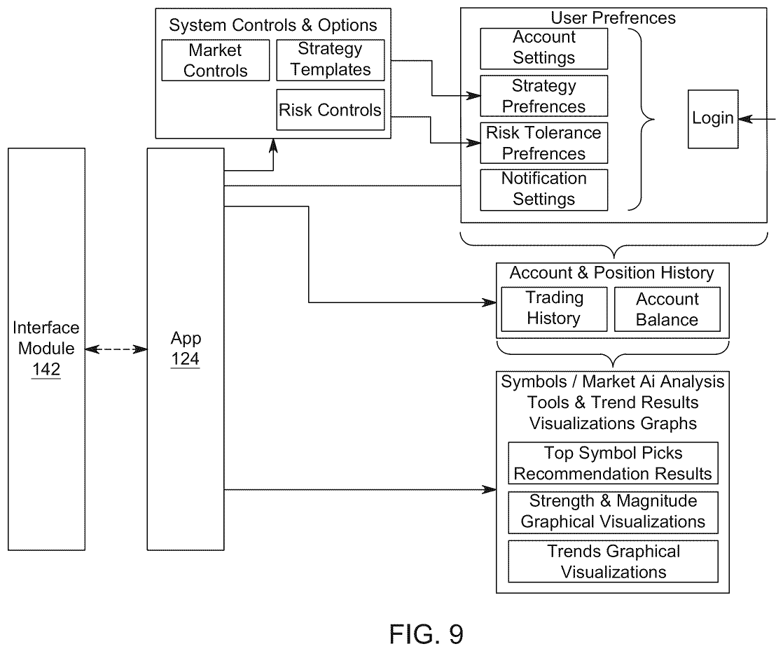

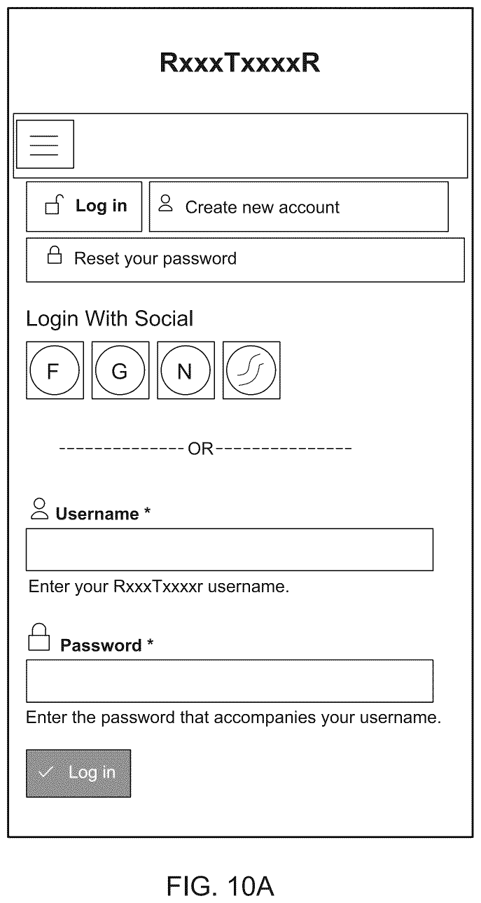

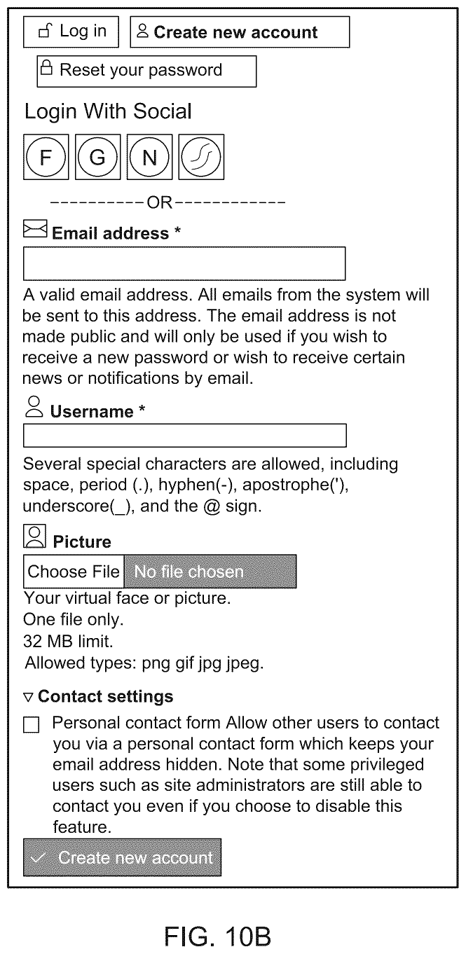

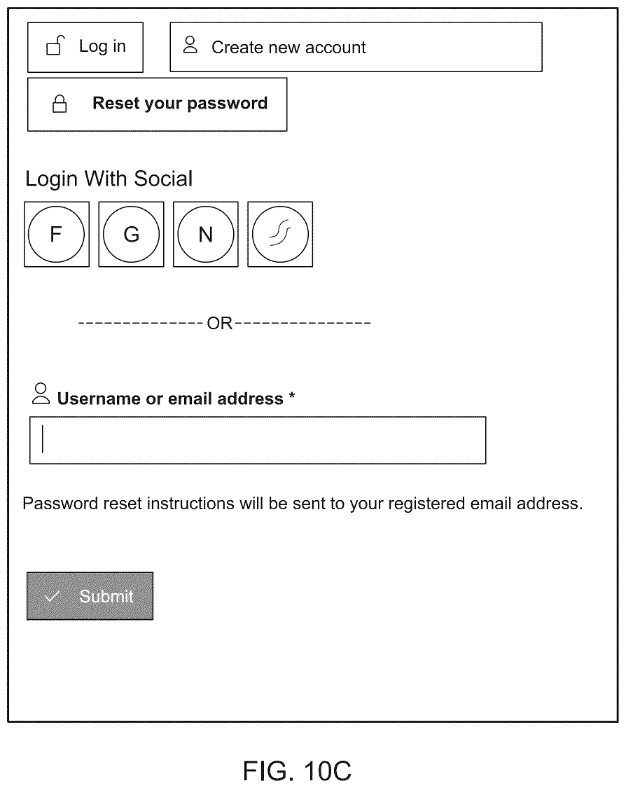

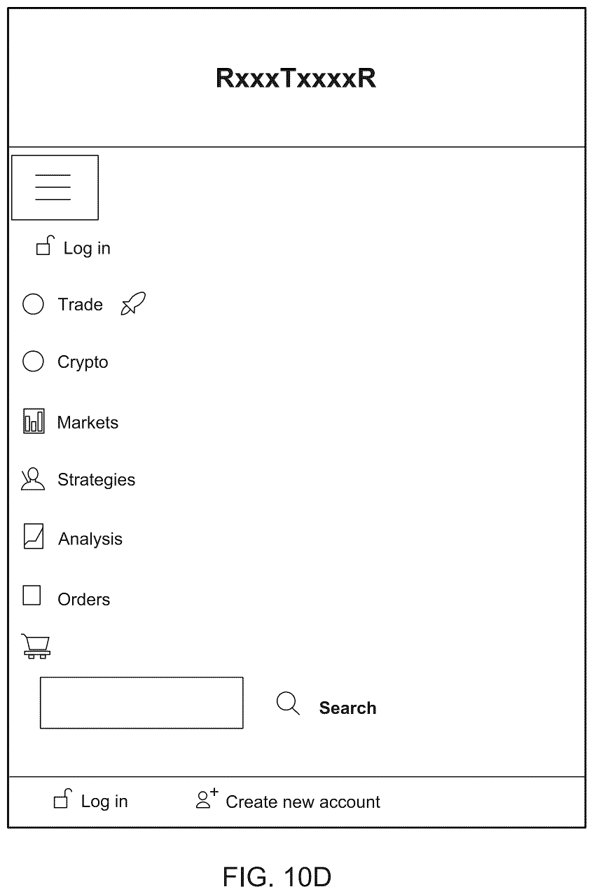

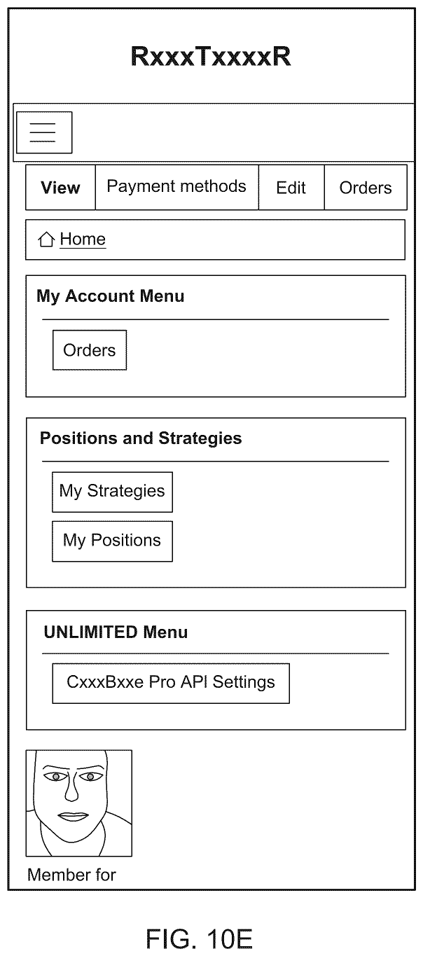

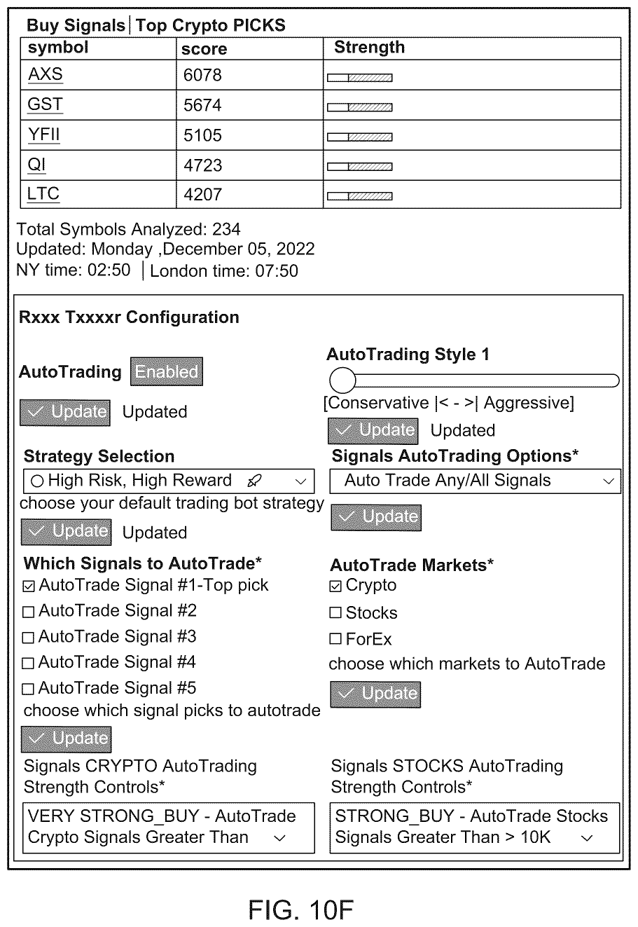

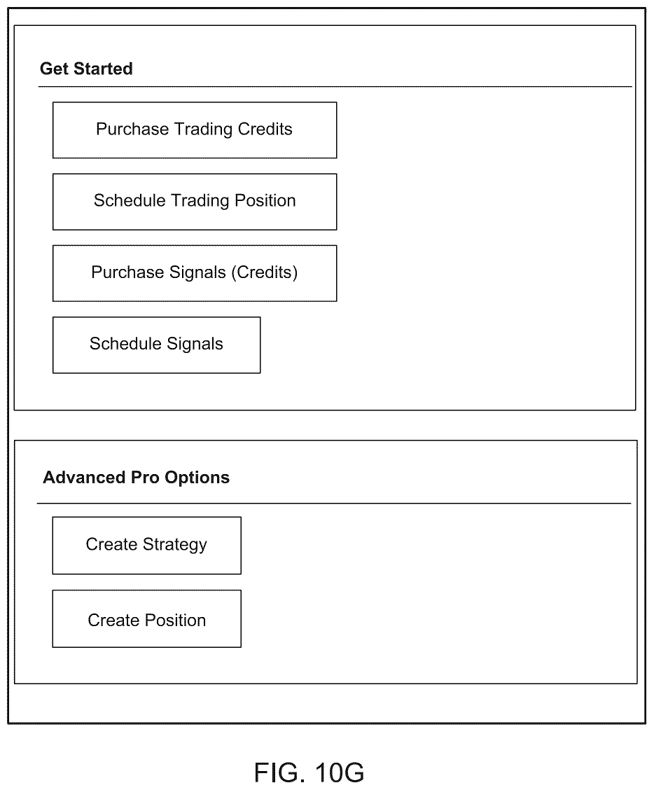

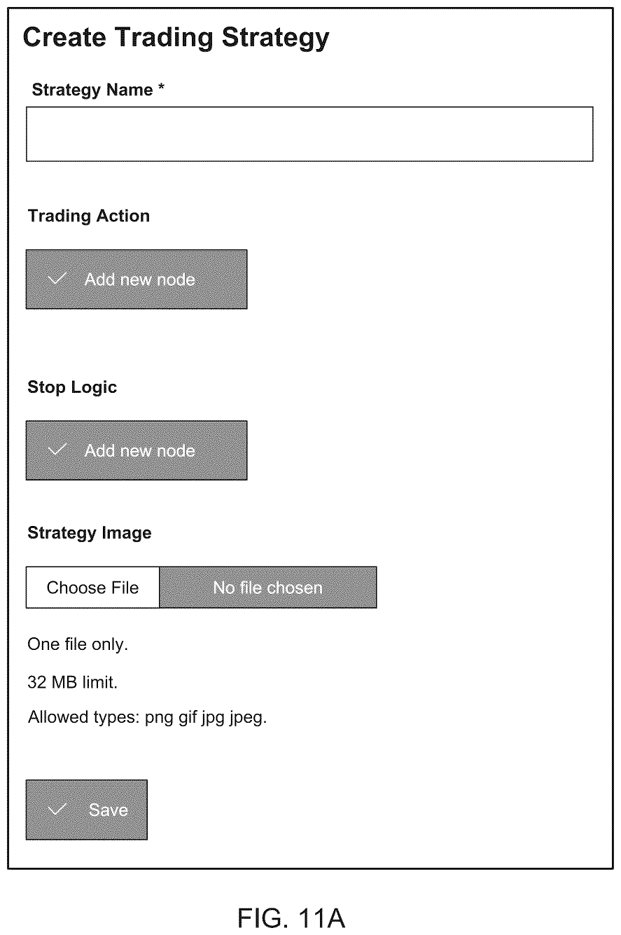

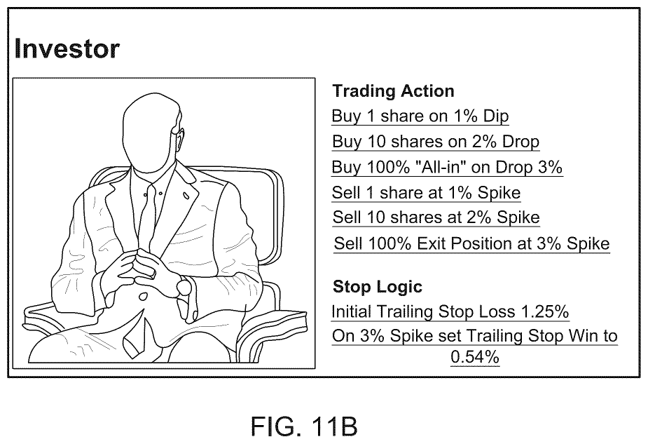

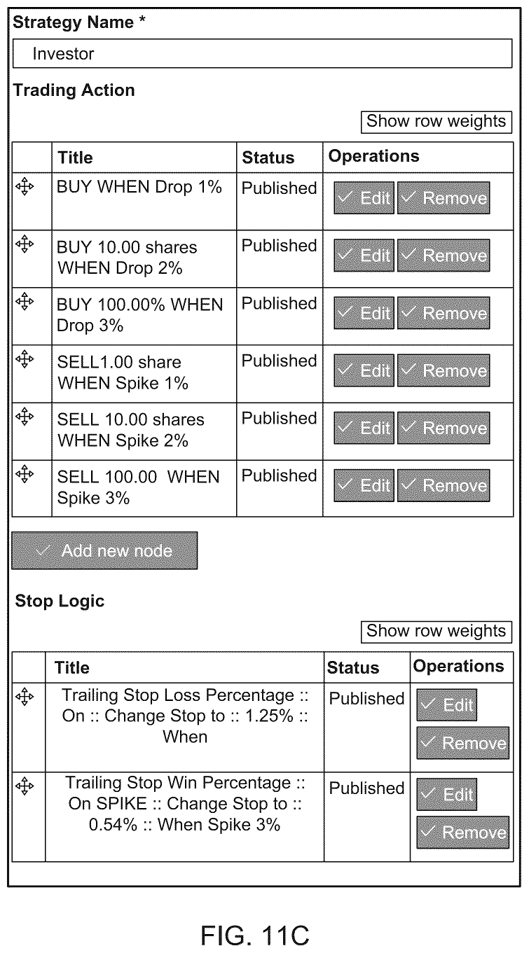

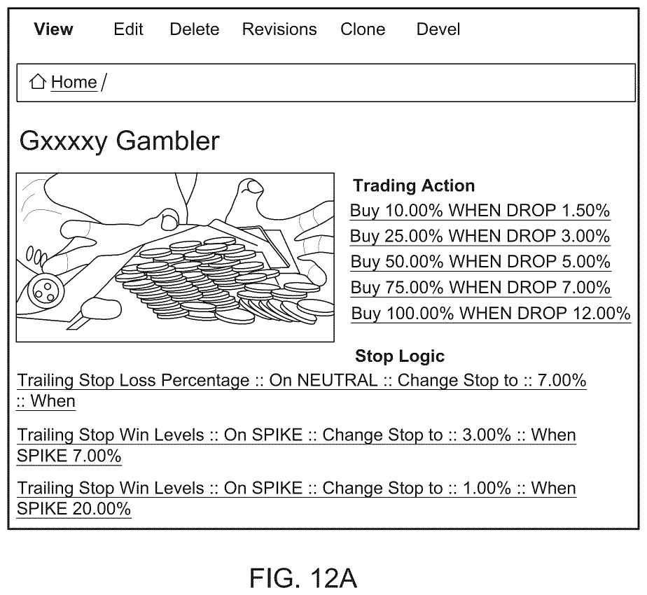

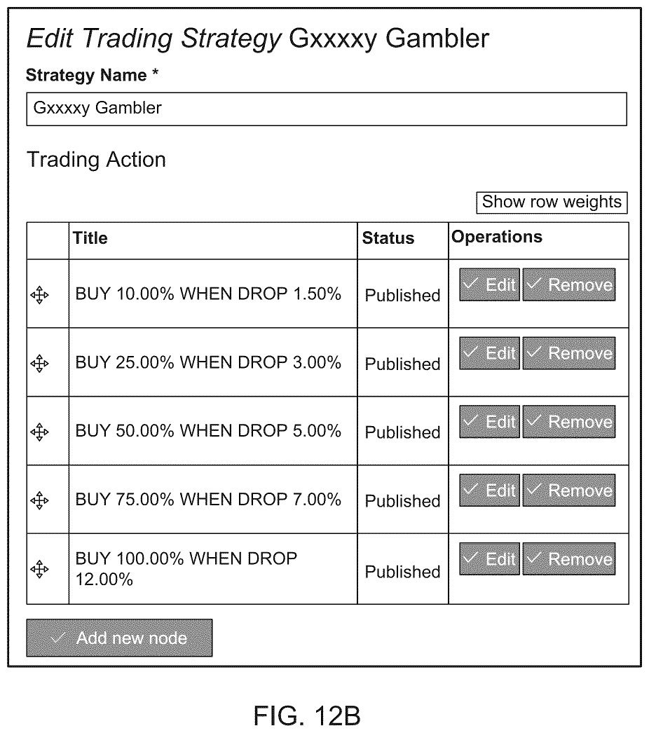

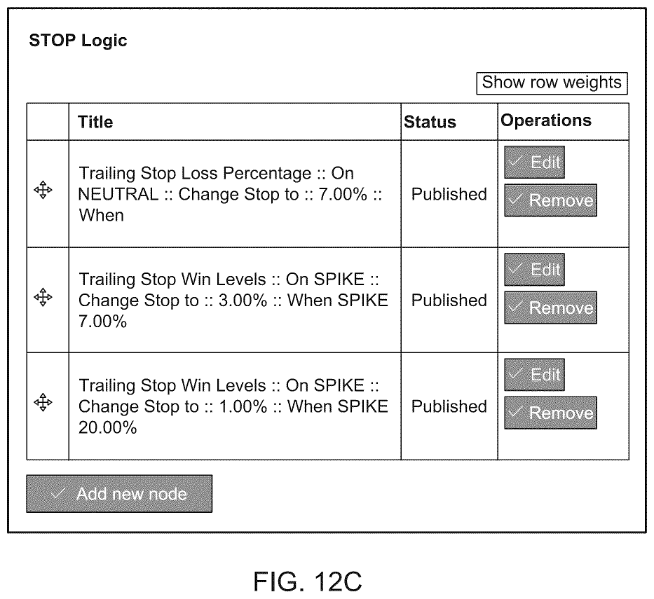

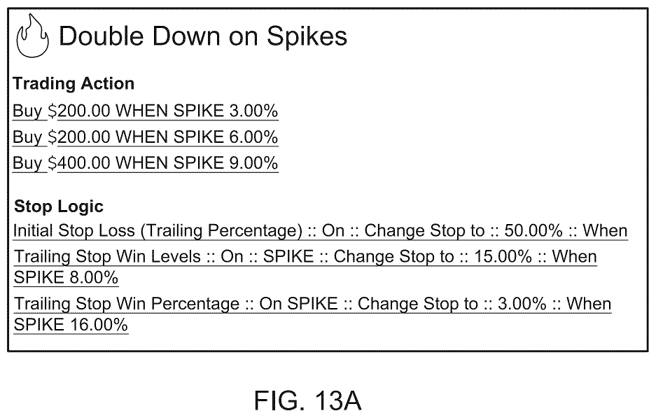

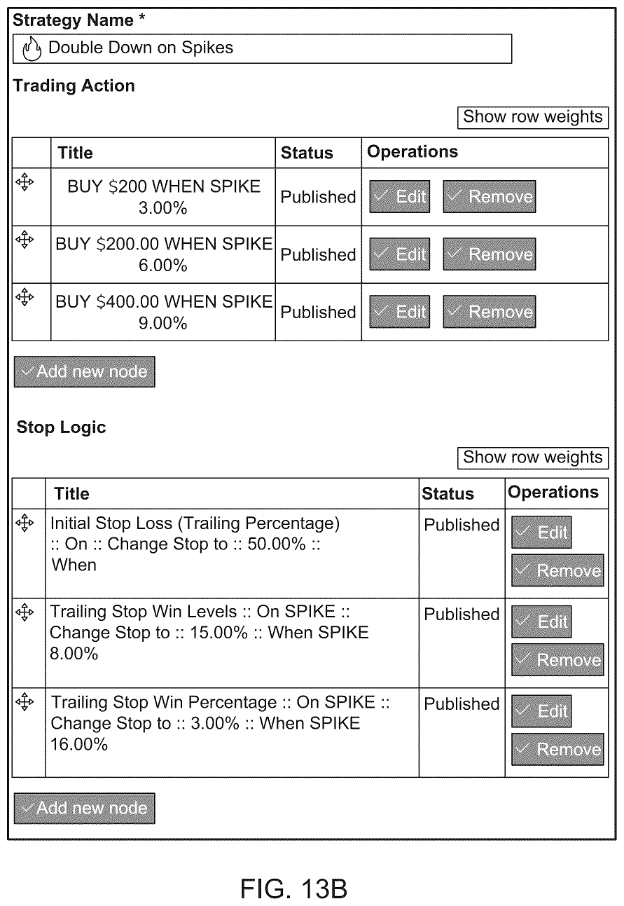

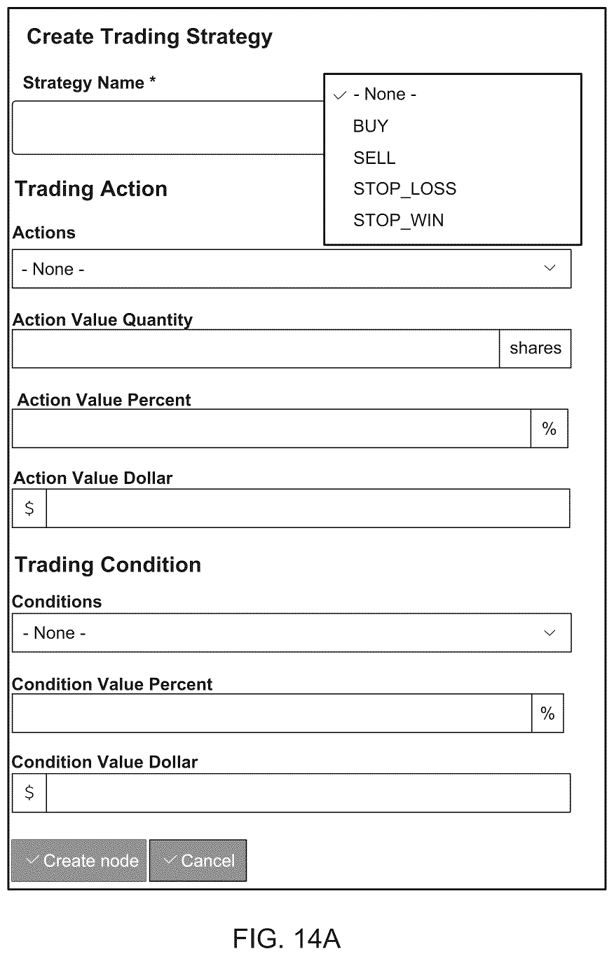

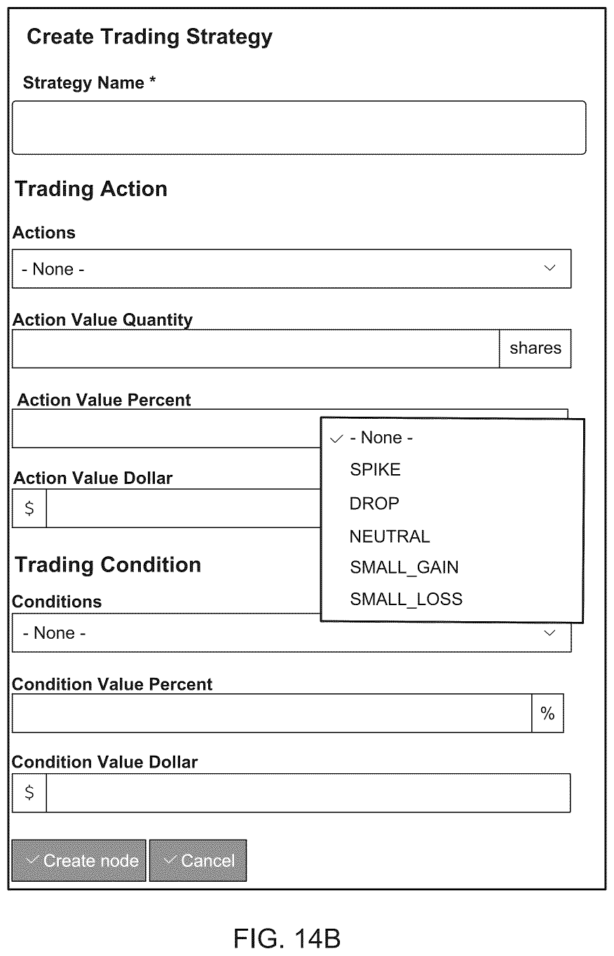

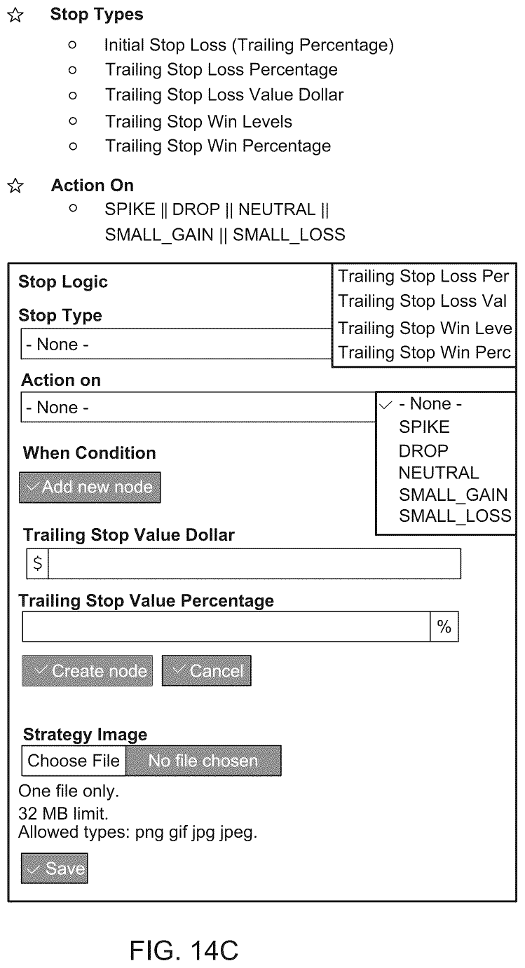

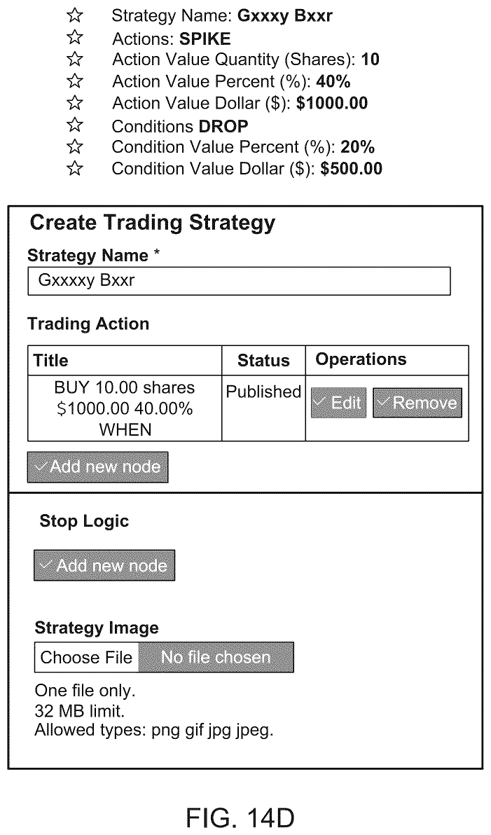

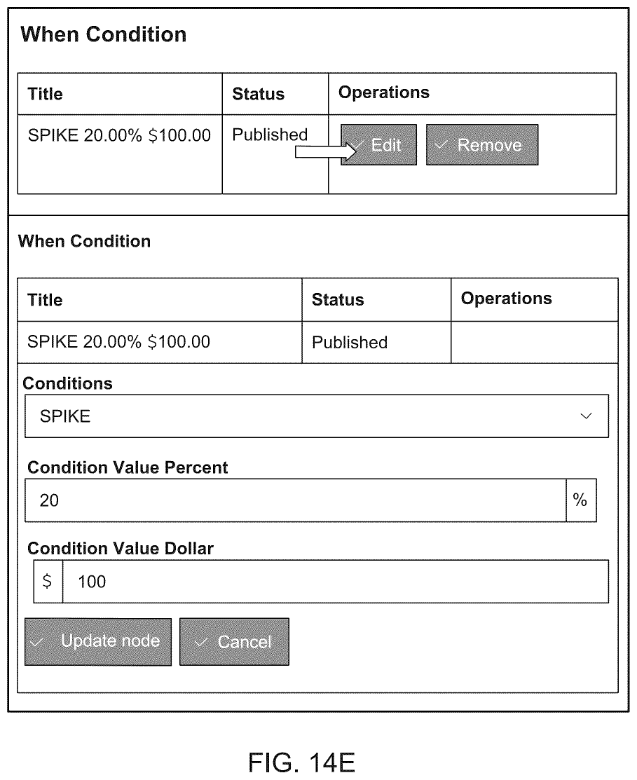

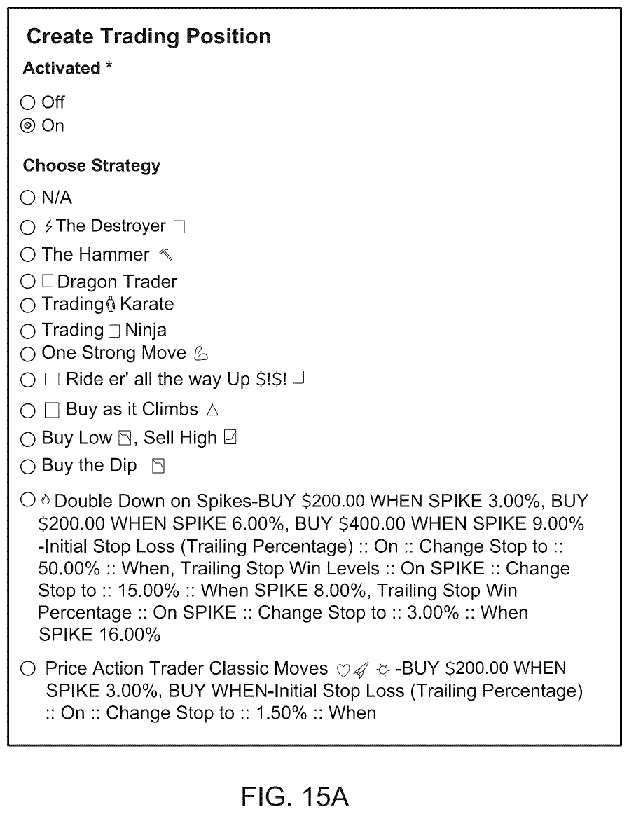

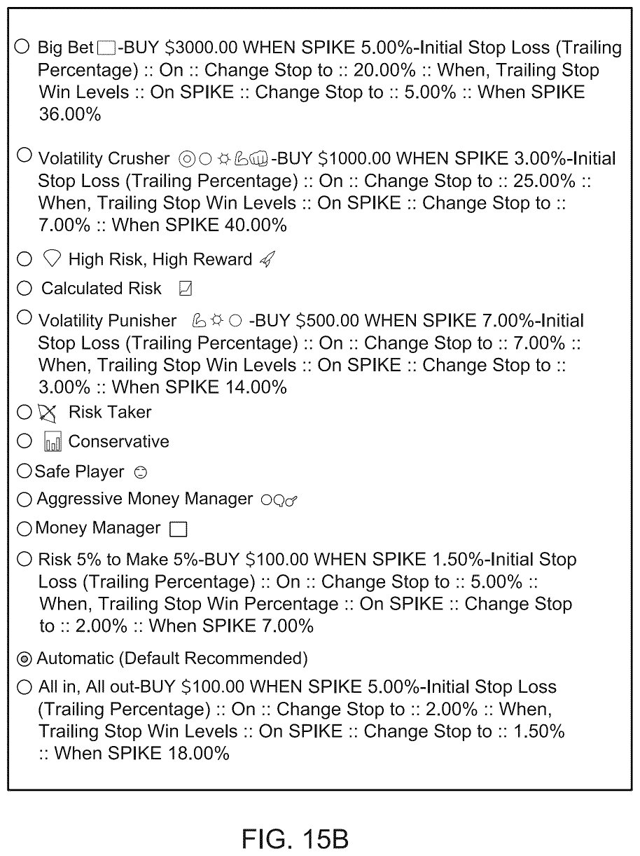

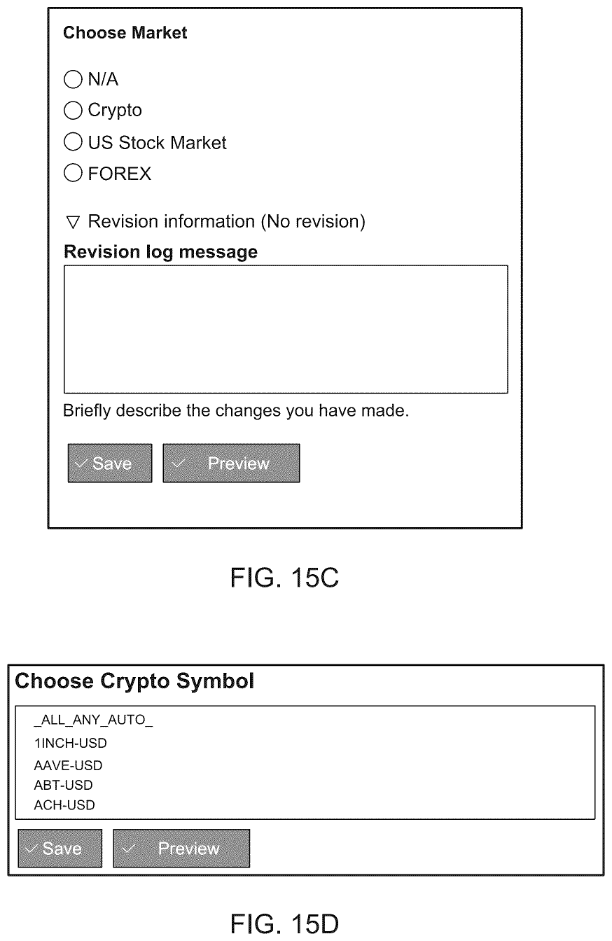

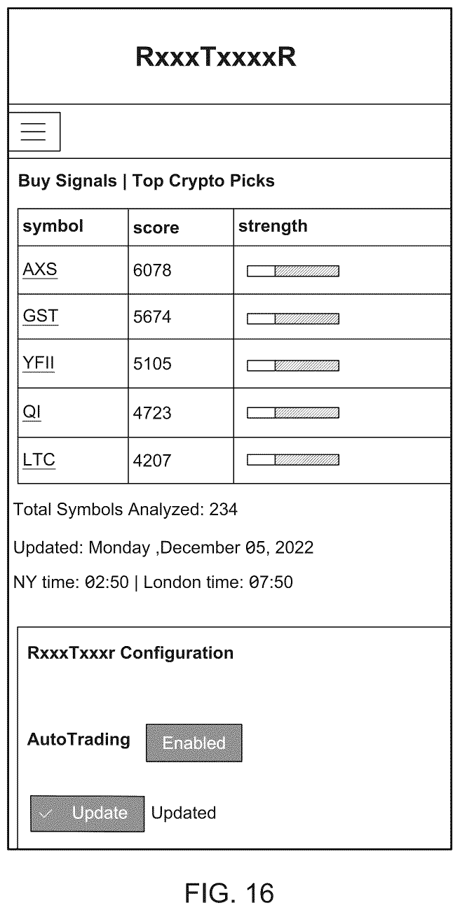

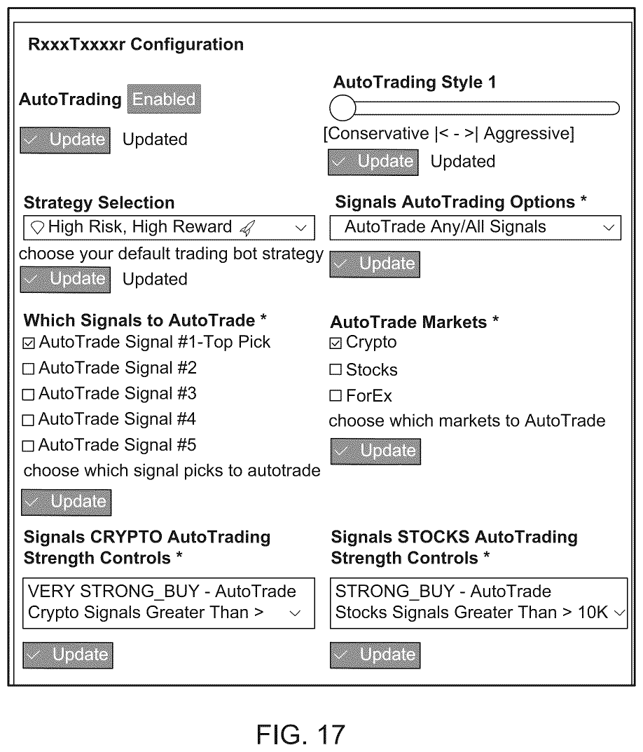

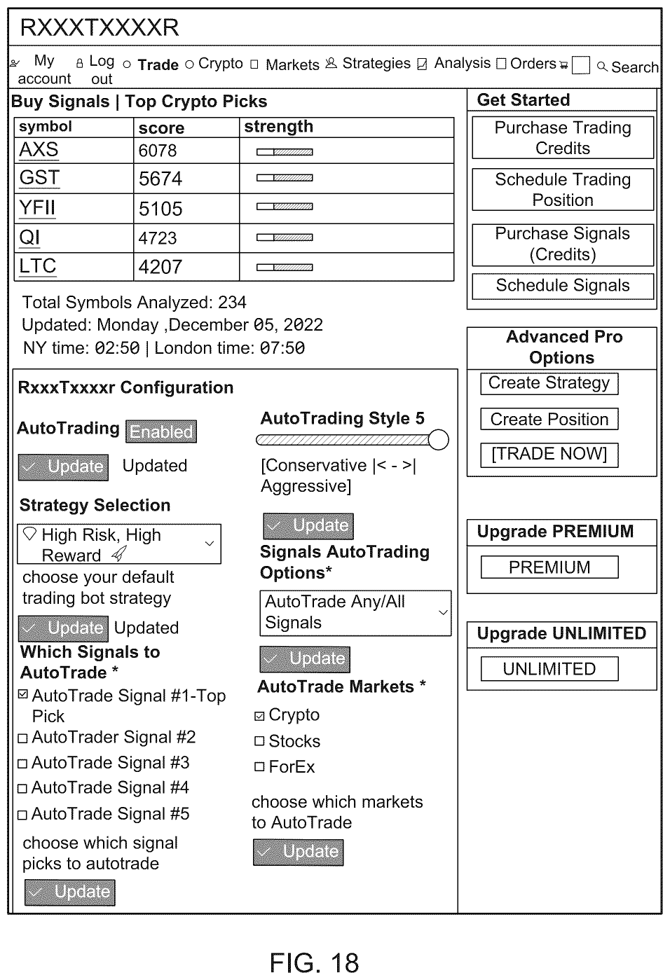

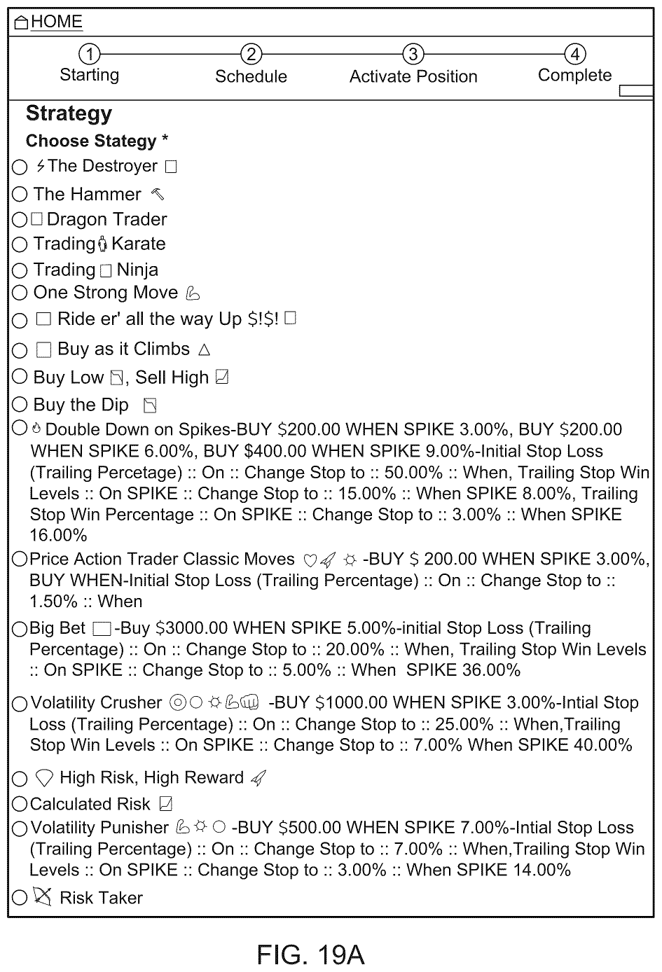

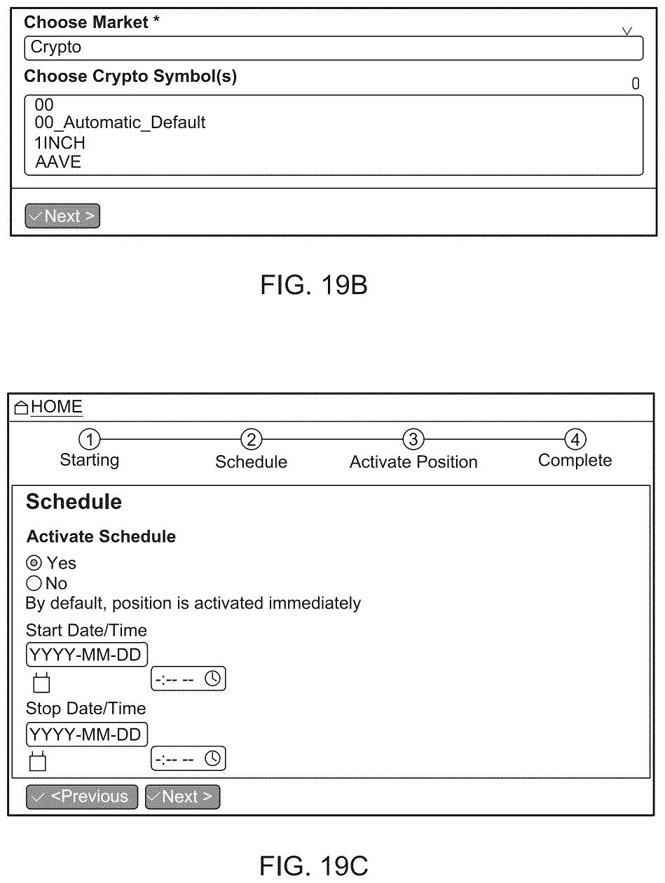

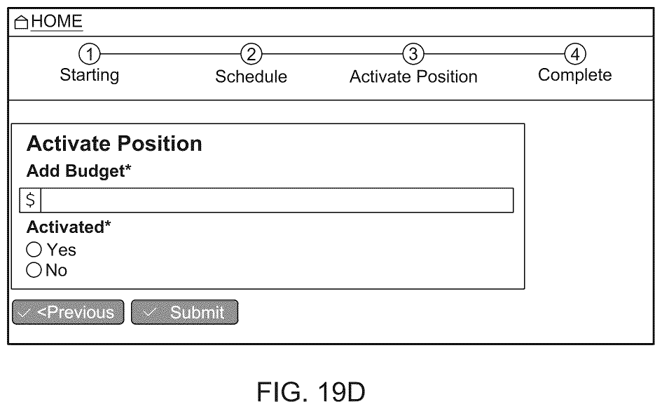

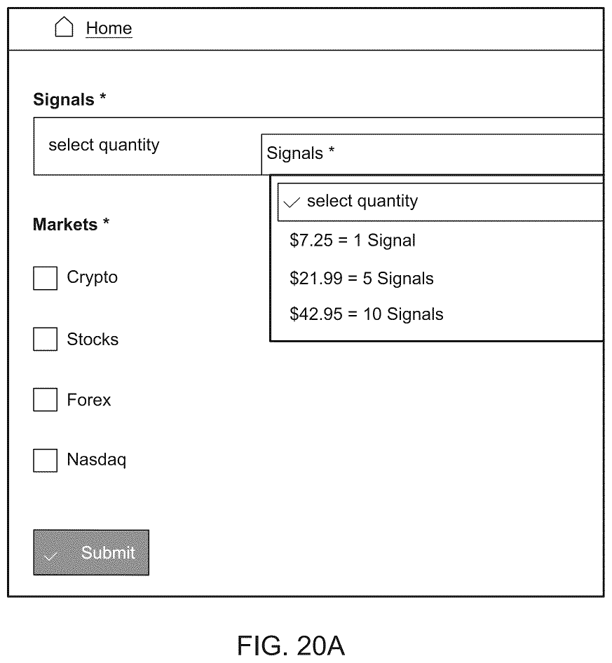

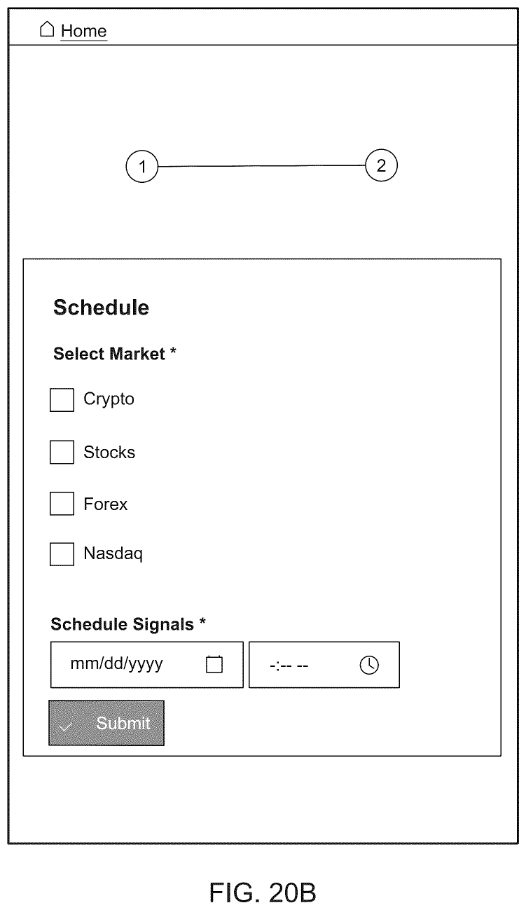

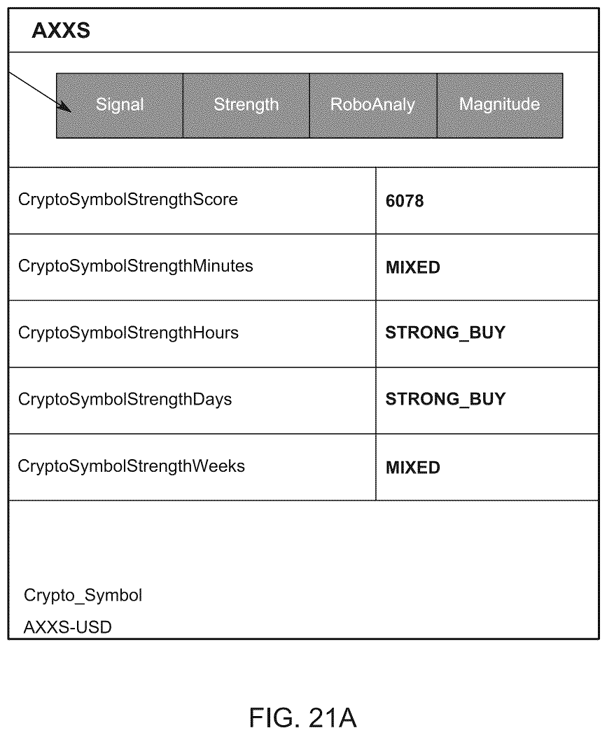

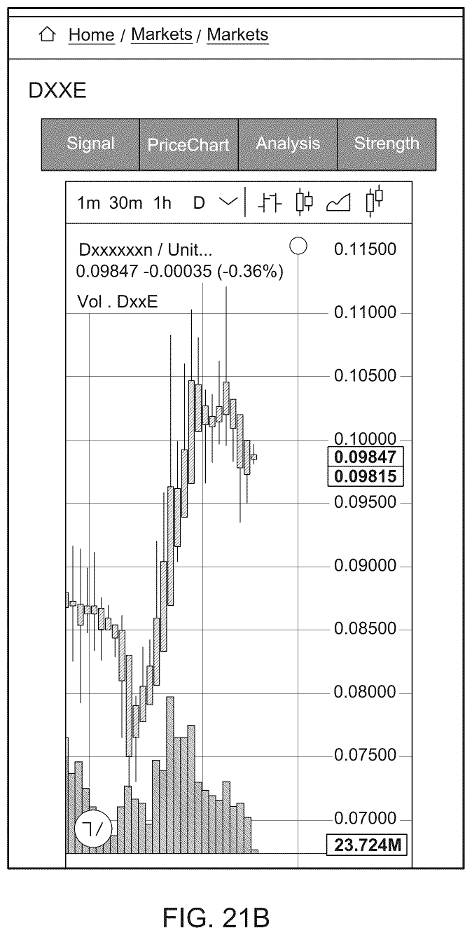

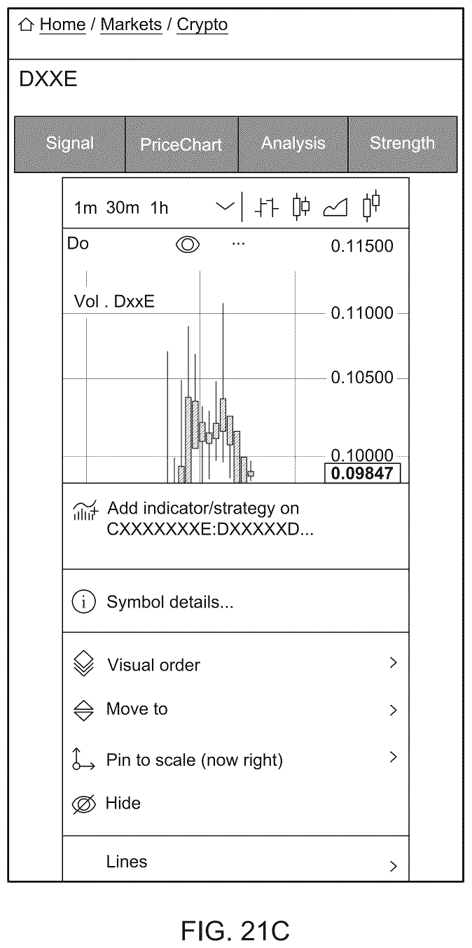

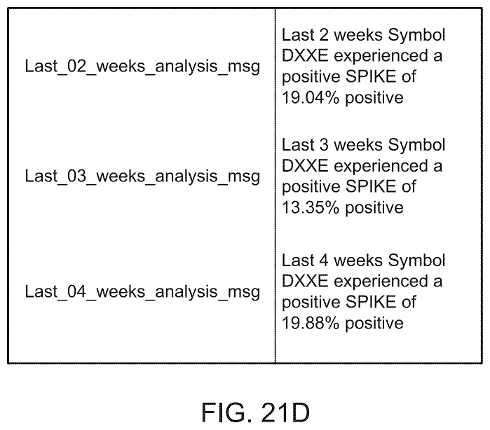

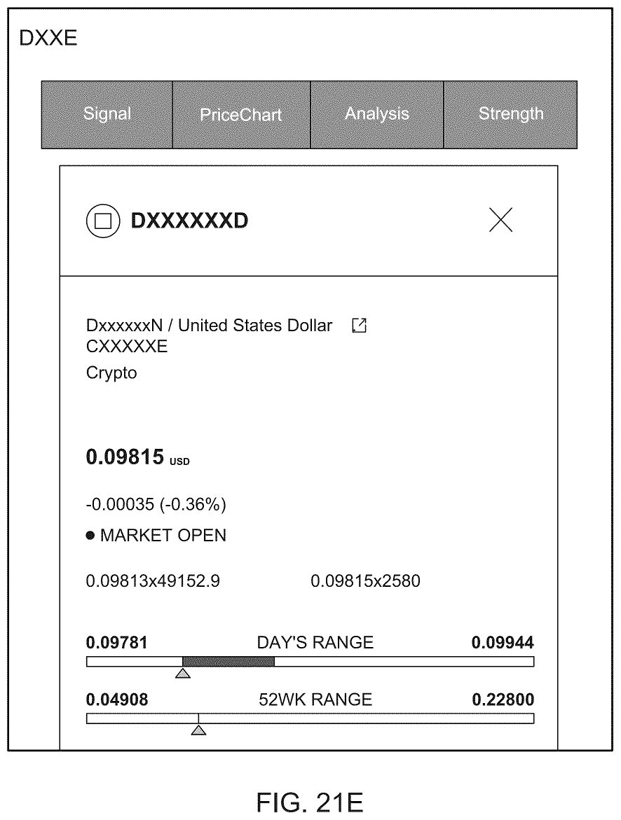

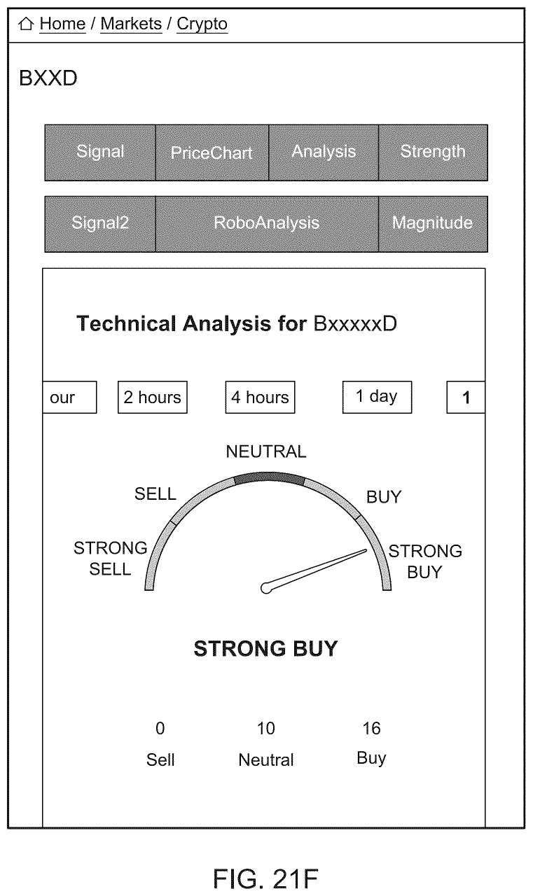

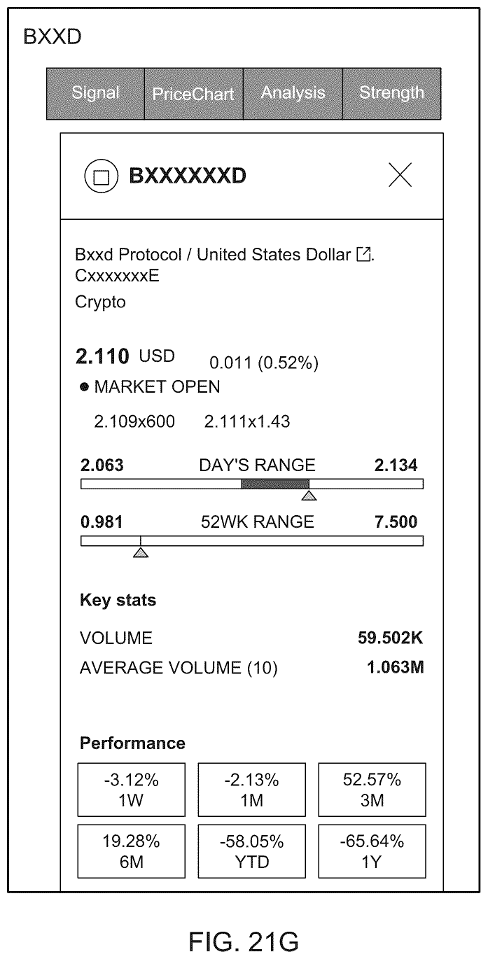

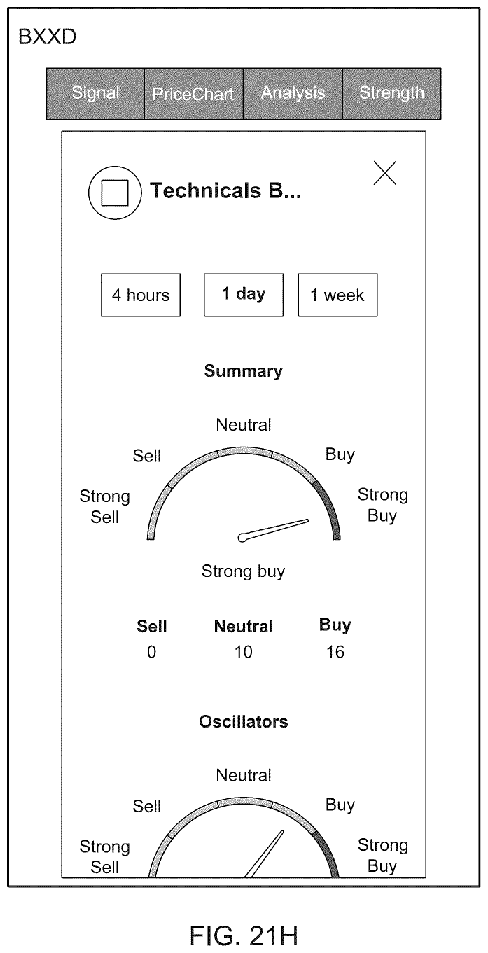

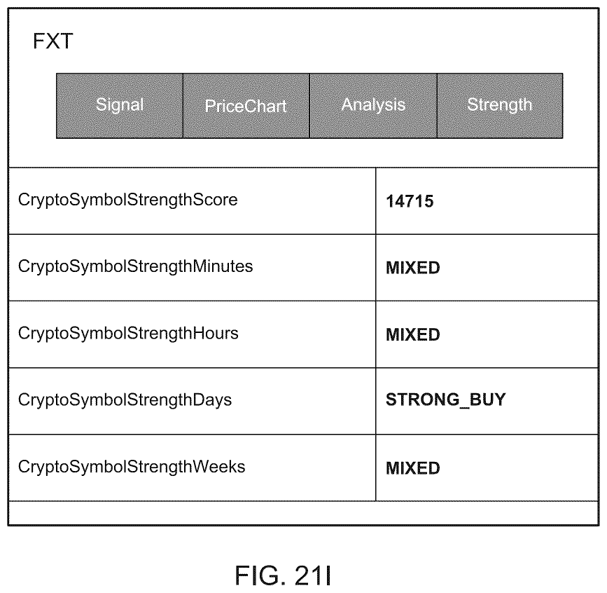

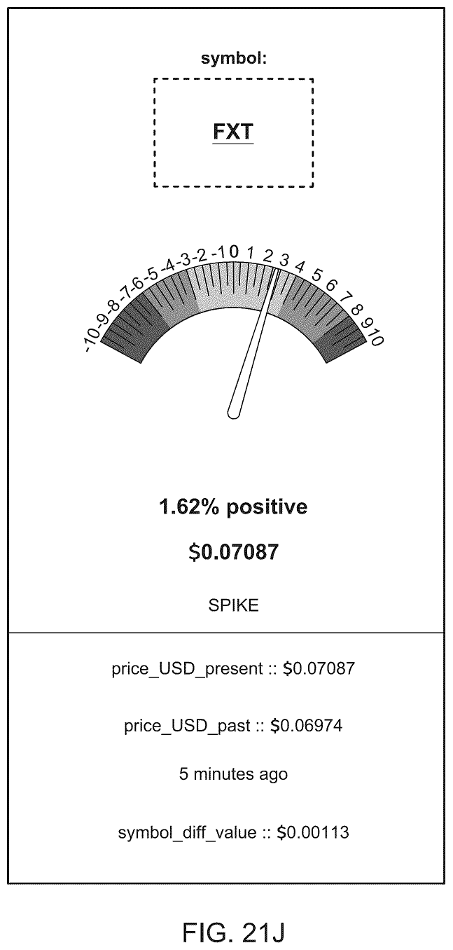

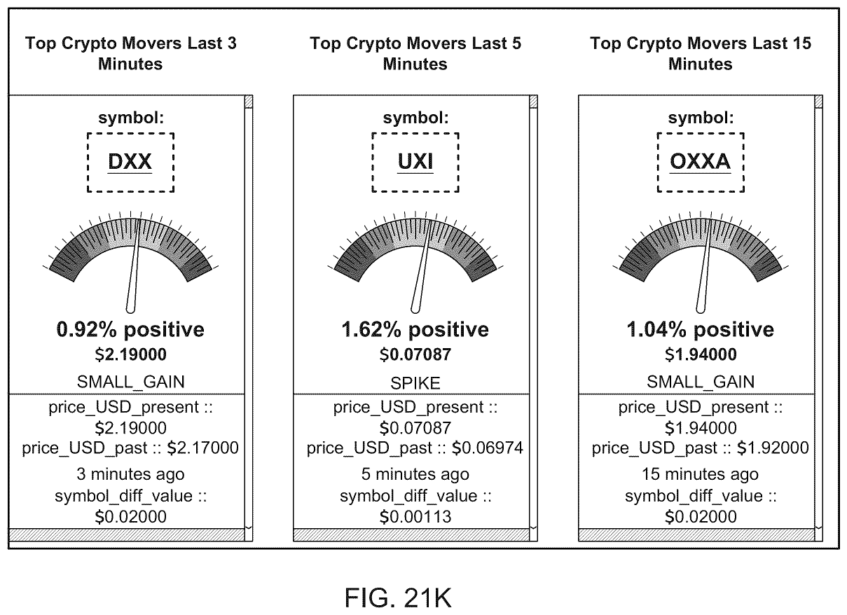

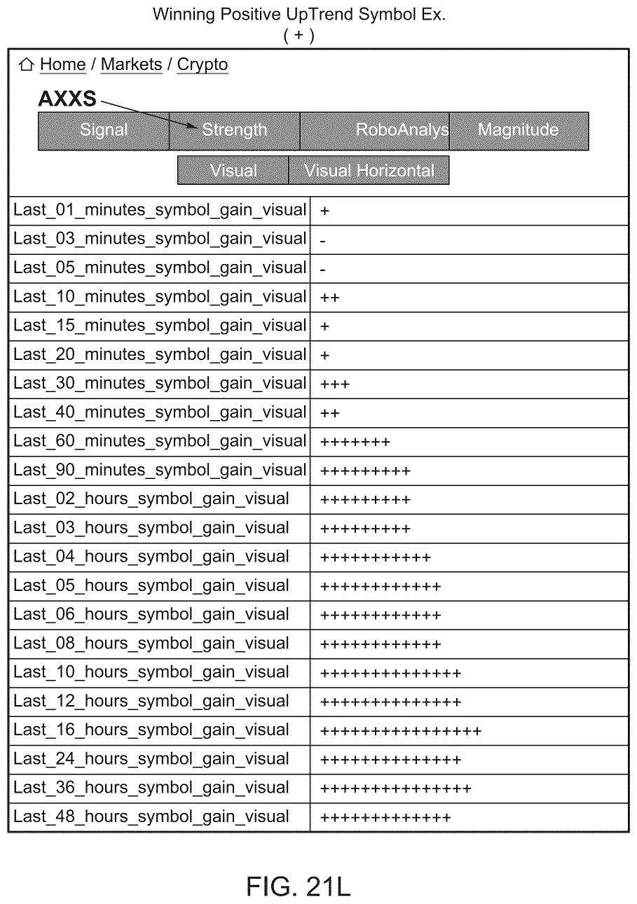

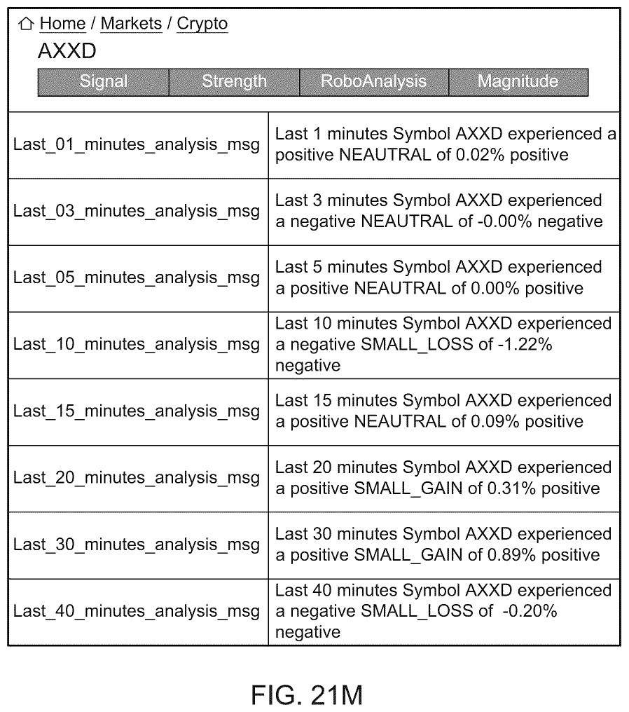

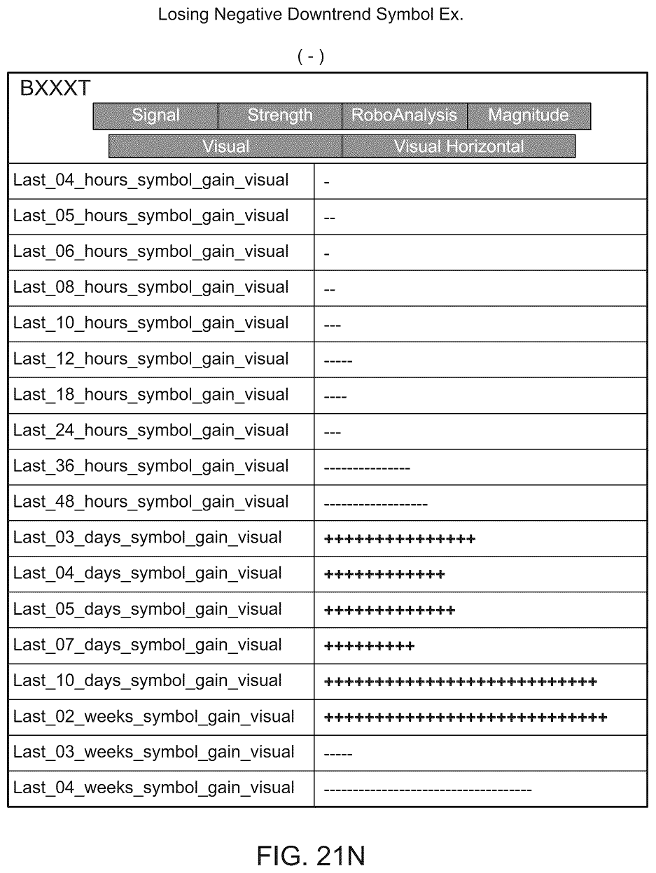

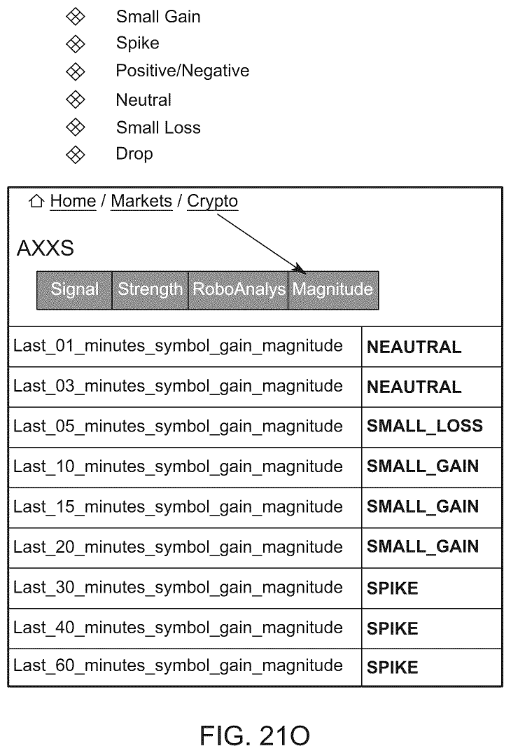

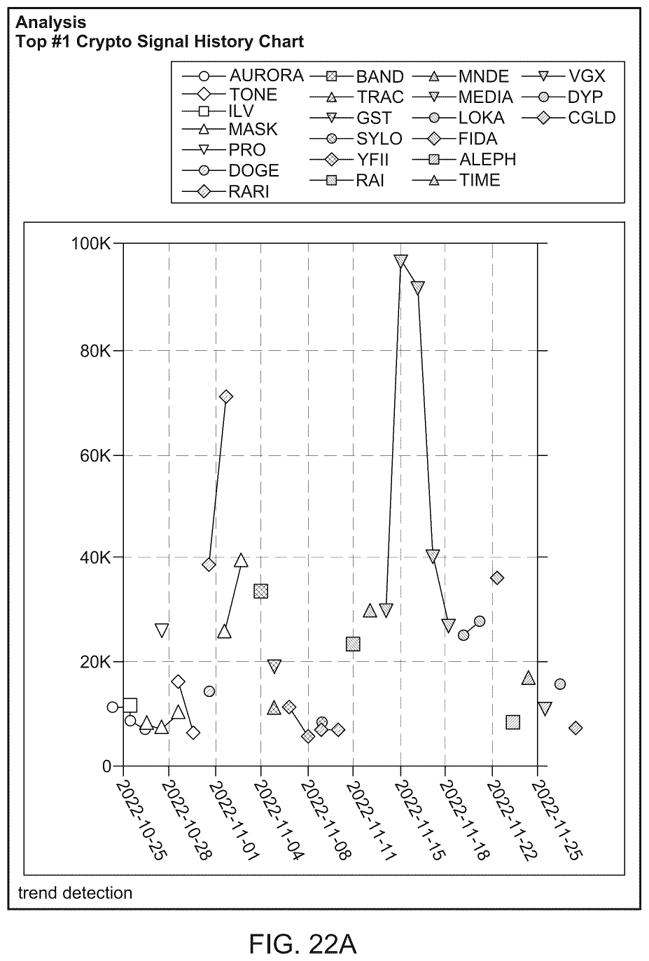

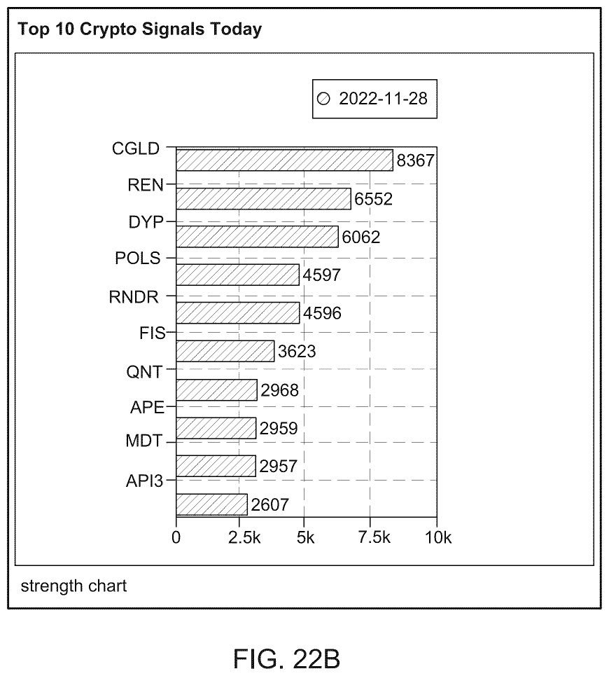

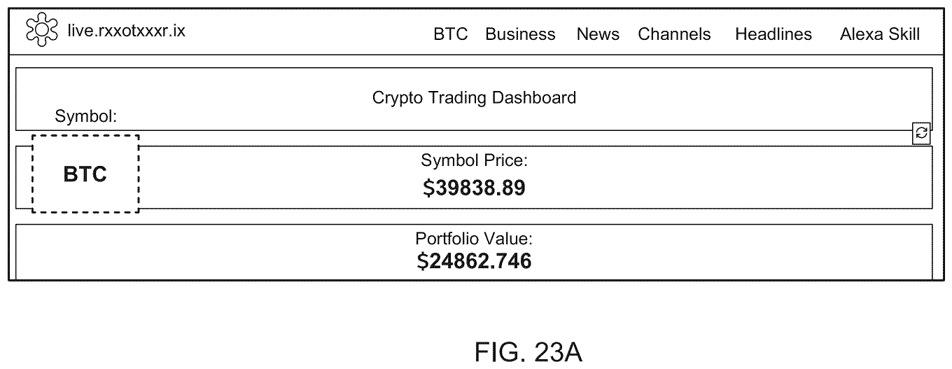

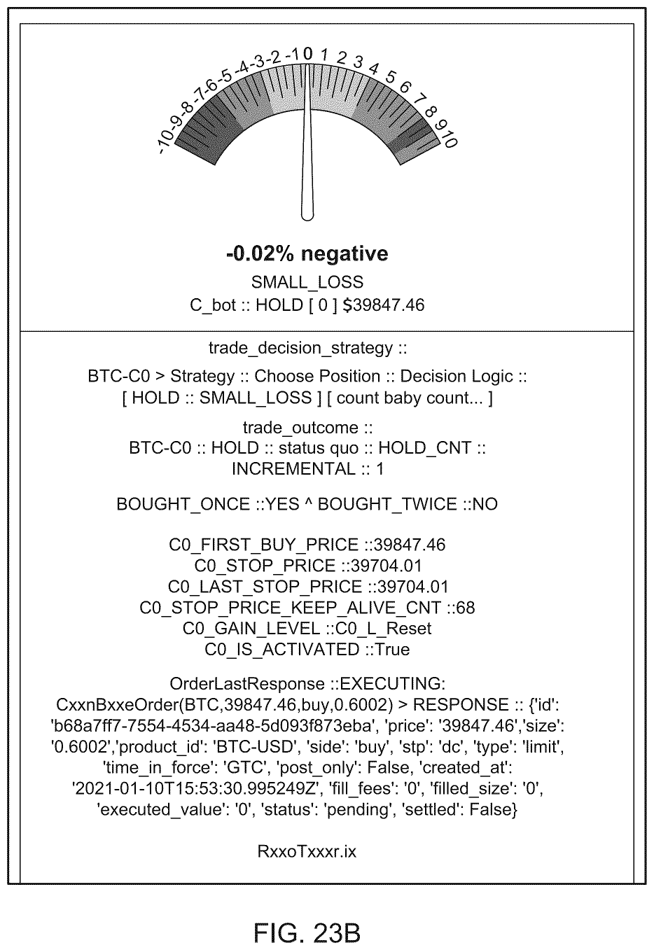

In the method and processes described above, the AI trading system 102, via the interface engine, can generate and provide various GUIs for interacting with the AI trading system 102. FIG. 9 illustrates a diagram of example interfaces that can be generated and provided by the interface module. FIGS. 10A-10G illustrate navigation interfaces generated AI trading system 102. FIGS. 11A-11C, 12A-12C, 13A, and 13B illustrate trading strategy interfaces generated by the AI trading system 102. FIGS. 14A-14E illustrate trading strategy creation interfaces generated by the AI trading system 102. FIGS. 15A-15D illustrate of trading position creation interfaces generated by the AI trading system 102. FIG. 16 illustrates a top picks interface generated by the AI trading system 102. FIG. 17 illustrates a diagram of a configuration interface generated by the AI trading system 102. FIG. 18 illustrates an overview interface generated by the AI trading system 102. FIGS. 19A-19D illustrate trading position creation interfaces generated by the AI trading system 102. FIGS. 20A and 20B illustrate trading position creation interfaces generated by the AI trading system 102. FIGS. 21A-21O illustrate trend interfaces generated by the AI trading system 102. FIGS. 22A and 22B illustrate analysis interfaces generated by the AI trading system 102. FIGS. 23A and 23B illustrate analysis interfaces generated by the AI trading system 102.

It should be understood, of course, that the foregoing relates to exemplary embodiments of the disclosure and that modifications can be made without departing from the spirit and scope of the disclosure as set forth in the following claims.

What is claimed is:

1. A method for electronic trading, the method comprising:
determining changes in value of a trading asset over a predetermined period of time, wherein the asset may be electronically traded;
calculating a score for the trading asset based on the changes in value of the asset over the predetermined period of time, wherein the score represents a magnitude change based on a weighted calculation of the changes in value at different times in the predetermined period of time;
generating a signal in response to the score meeting a predetermined threshold; and
transmitting the signal to one or more targets.

2. The method of claim 1, the method further comprising:
determining values of the asset during the predetermined period of time; and
storing the values of the asset in a database indexed with a symbol for the asset, wherein the changes in value of the asset are determined from the database.

3. The method of claim 2, wherein the asset includes a pair of assets and the values of the asset comprise a value exchange between the pair of assets.

4. The method of claim 1, the method further comprising:
determining a trading strategy for the asset;
electronically generating a trading position for the asset based on the trading strategy; and
monitoring the trading position using one or more machine-learning algorithms.

5. The method of claim 4, wherein determining a trading strategy is based on a signal.

6. The method of claim 4, the method further comprising:
altering the trading position based on a new signal.

7. The method of claim 1, wherein the one or more targets comprise at least one of a user device and an artificial intelligence trading system.

8. A computer-readable medium storing instructions that cause one or more processors to perform a method, the method comprising:
determining changes in value of a trading asset over a predetermined period of time, wherein the asset may be electronically traded;
calculating a score for the trading asset based on the changes in value of the asset over the predetermined period of time, wherein the score represents a magnitude change based on a weighted calculation of the changes in value at different times in the predetermined period of time;
generating a signal in response to the score meeting a predetermined threshold; and
transmitting the signal to one or more targets.

9. The computer-readable medium of claim 8, the method further comprising:
determining values of the asset during the predetermined period of time; and
storing the values of the asset in a database indexed with a symbol for the asset, wherein the changes in value of the asset are determined from the database.

10. The computer-readable medium of claim 9, wherein the asset includes a pair of assets and the values of the asset comprise a value exchange between the pair of assets.

11. The computer-readable medium of claim 8, the method further comprising:
determining a trading strategy for the asset;
electronically generating a trading position for the asset based on the trading strategy; and
monitoring the trading position using one or more machine-learning algorithms.

12. The computer-readable medium of claim 11, wherein determining a trading strategy is based on a signal.

13. The computer-readable medium of claim 11, the method further comprising:
altering the trading position based on a new signal.

14. The computer-readable medium of claim 8, wherein the one or more targets comprise at least one of a user device and an artificial intelligence trading system.

15. A system comprising:
one or more memory devices storing instructions;
one or more processors configured to execute the instructions to perform a method, the method comprising:
determining changes in value of a trading asset over a predetermined period of time, wherein the asset may be electronically traded;
calculating a score for the trading asset based on the changes in value of the asset over the predetermined period of time, wherein the score represents a magnitude change based on a weighted calculation of the changes in value at different times in the predetermined period of time;
generating a signal in response to the score meeting a predetermined threshold; and
transmitting the signal to one or more targets.

16. The system of claim 15, the method further comprising:
determining values of the asset during the predetermined period of time; and
storing the values of the asset in a database indexed with a symbol for the asset, wherein the changes in value of the asset are determined from the database.

17. The system of claim 16, wherein the asset includes a pair of assets and the values of the asset comprise a value exchange between the pair of assets.

18. The system of claim 15, the method further comprising:
determining a trading strategy for the asset;
electronically generating a trading position for the asset based on the trading strategy; and
monitoring the trading position using one or more machine-learning algorithms.

19. The system of claim 18, the method further comprising:
altering the trading position based on a new signal.

20. The system of claim 15, wherein the one or more targets comprise at least one of a user device and an artificial intelligence trading system.
